(19) United States
(12) Patent Application Publication
(10) Pub. No.: US 2004/0044964 A1
(43) Pub. Date: Mar. 4, 2004

(54) Behavior of anchored frames

(75) Inventors: Andreas Martens, Hamburg (DE); Frank Meies, Stelle (DE); Falko Tesch, Hamburg (DE)

Correspondence Address: Lisa A. Norris, Gunnison, McKay & Hodgson, L.L.P., Suite 220, 1900 Garden Road, Monterey, CA, 93940, US

(73) Assignee: Sun Microsystems, Inc.

(21) Appl. No.: 10/651,883

(22) Filed: Aug. 29, 2003

(30) Foreign Application Priority Data
Aug. 29, 2002 (EP) 02019106.0

(51) Int. Cl. G06F 17/00

(52) U.S. Cl. 715/517

(57) ABSTRACT

A frame growth direction of an anchored frame is adapted to various combinations of page text flow directions and page line growth directions of an underlying page and of an anchored frame, thus reducing interference of a growing anchored frame with an existing layout of the underlying page, other anchored frame, or document. In one embodiment, a method for defining the anchored frame in the page having text elements includes determining a page text flow direction of the page, determining a page line growth direction of the page, locating an anchor point of the anchored frame near an intersection of the page text flow direction and the page line growth direction of the page, and defining a frame growth direction of the anchored frame to be oriented away from the anchor point to reduce interference with the text elements in the page.

### BACKGROUND OF THE INVENTION

1. Field of the Invention

The present invention relates generally to the display of data. More particularly, the present invention relates to defining an anchored frame in a page having text elements.

2. Description of Related Art

With continuously increasing processing capabilities of computing devices and increased proliferation of computers in offices and homes, computers became valuable assistants in nearly all application environments. For example, computer applications are widely used in the field of information processing, including applications for generating or processing text documents, applications for layout and design of documents, spreadsheet applications with information, applications for web page design and similar.

Some prior art applications arranged text portions or text frames in certain regions of a page. In some prior art applications, the text frame was anchored in the page or in another frame. Accordingly, some documents generated by some of the prior art applications contained a plurality of text regions or text frames associated with one another used to generate a particular layout of a text document, a web page, or similar document.

In some prior art applications, the text frame had a predefined or default initial size, e.g., if inserted into a page, and was filled with information, such as characters or symbols. Conventionally, information was input to the text frame through a keyboard device. Depending on the size of the text frame, the size and amount of information, the text frame was slowly filled until the entire area of the text frame was occupied. If further information was input into the text frame, to avoid exceeding the area of the text frame, some prior art text frames grew by some finite amount depending on the further amount of information inserted. For example, a text frame containing horizontal lines of information, such as in the English or German writing styles, grew in a downward direction as a further line of information was included.

### SUMMARY OF THE INVENTION

In accordance with one embodiment of the invention a method for defining an anchored frame in a page having text elements includes: determining a page text flow direction of the page; determining a page line growth direction of the page; locating an anchor point of the anchored frame near an intersection of the page text flow direction and the page line growth direction of the page; and defining a frame growth direction of the anchored frame oriented away from the anchor point to reduce interference with the text elements of the page. Accordingly, the frame growth direction of the anchored frame is adapted to various combinations of page text flow directions and page line growth directions of an underlying page and of an anchored frame, thus reducing interference of a growing anchored frame with an existing layout of a page, other text frame, or document.

### BRIEF DESCRIPTION OF THE DRAWINGS

FIG. 1 illustrates a process flow diagram of a method for defining an anchored frame in a page having text elements in accordance with one embodiment of the invention;

FIGS. 2A and 2B illustrate elements of a system for defining an anchored frame in a page having text elements in accordance with one embodiment of the invention;

FIG. 3 illustrates a process flow diagram of a method for defining an anchored frame in a page having text elements in accordance with another embodiment of the invention;

FIGS. 4A-4H each illustrate an example of a page generated by or for a text processing application in accordance with embodiments of the invention;

FIG. 5 illustrates a process flow diagram of a method for defining an anchored frame in a page having text elements in accordance with another embodiment of the invention;

FIGS. 6A and 6B illustrate examples of defining an anchored frame in a page when the page text flow direction and the frame text flow direction of the anchored frame are opposite to one another in accordance with another embodiment of the invention;

FIG. 7 illustrates a process flow diagram of a method for defining an anchored frame in a page having text elements in accordance with another embodiment of the invention;

FIGS. 8A and 8B illustrate relocating an anchor point based on a change of the writing style of a page in accordance with another embodiment of the invention;

FIG. 9 illustrates a process flow diagram of a method for defining an anchored frame in a page having text elements in accordance with another embodiment of the invention;

FIGS. 10A and 10B illustrate relocating an anchor point and repositioning an anchored frame in accordance with changes to a writing style of a page underlying the anchored frame in accordance with another embodiment of the invention;

FIG. 11 illustrates a process flow diagram of a method for defining an anchored frame in a page having text elements in accordance with another embodiment of the invention;

FIG. 12 illustrates a process flow diagram of a method for defining an anchored frame in a page having text elements in accordance with another embodiment of the invention;

FIG. 13 illustrates a process flow diagram of a method for defining an anchored frame in a page having text elements in accordance with another embodiment of the invention;

FIG. 14 illustrates a process flow diagram of a method for defining an anchored frame in a page having text elements in accordance with another embodiment of the invention;

FIGS. 15A and 15B illustrate an example of defining an anchored frame in a page if the anchored frame is moved to a second page in accordance with one embodiment of the invention;

FIG. 16 illustrates a process flow diagram of a method for defining an anchored frame in a page having text elements in accordance with another embodiment of the invention; and

FIG. 17 illustrates a system for defining an anchored frame in a page having text elements in accordance with one embodiment of the invention.

### DETAILED DESCRIPTION

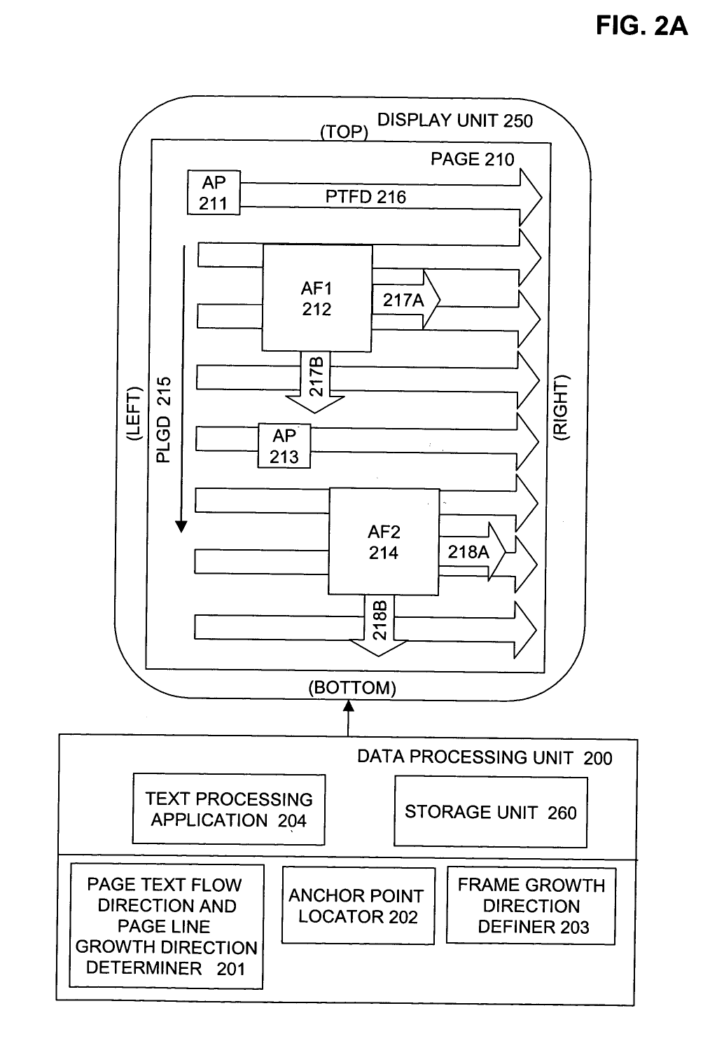

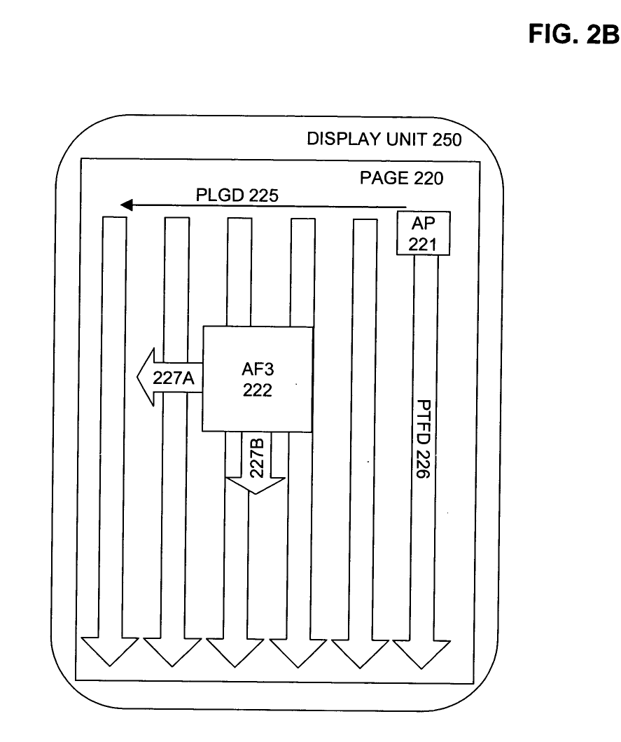

With the increased proliferation of computing devices and a growing use of communication networks larger communities of users access and provide information. Thus, increasingly documents are provided for or provided by users accustomed to different writing styles. In a computing or word processing environment, the documents are typically provided in a format representing a page and defining an area bounded by two parallel vertical sides and two parallel horizontal sides within which text elements can be entered, such as according to a defined writing style. Thus, conventionally, a page has a left side, a right side, a top side and a bottom side (see for example FIG. 2A).

For example, countries using the European writing style conventionally use text elements arranged in horizontal lines in a left to right text flow direction. Further, consecutive lines are appended below previous lines such that a text frame generally grows in a downward direction as further text lines are included. Additionally, text frames are typically anchored in an upper left corner of a page or text portion of another text frame.

Differently, the Arabic writing style has a text flow direction from right to left in horizontal lines. Further, various countries in Asia utilize a writing style having a text flow direction with consecutive text columns arranged in vertical columns in a right to left direction such as the Japanese and Chinese writing styles. Thus, a first text element is typically located near the upper right corner of a text portion. Differently, the Mongolian writing style utilizes a vertical text flow direction with consecutive text columns arranged from left to right.

When different writing styles, for example, horizontal left to right and vertical, are combined on pages, a predefined growth direction of a text frame anchored or positioned on a page often interferes with the text layout of the page and causes cumbersome rearrangements of the layout of the page to adapt the layout of the page to the combination of writing styles.

These above problems are particularly prominent in a network environment, where a text processing application needs to accommodate a plurality of different users. These above problems also occur if an application is loaded onto computing devices operated by users having different writing style preferences.

Viewed broadly, embodiments in accordance with the invention modify a frame growth direction of an anchored frame to adapt to various combinations of text flow directions and line growth directions of an underlying page and of an anchored frame, thus reducing interference of the growing anchored frame with an existing layout of the page, other text frame(s) or document. In some embodiments, the various methods of the invention are incorporated into a text processing application adapted for use with the invention, such as an application for generating or processing text documents or documents including text, such as text processes, spreadsheet applications, web pages or programs for the layout of web pages or text documents. In other embodiments, the various methods of the invention are implemented as a separate process or processes cooperating with a text processing application.

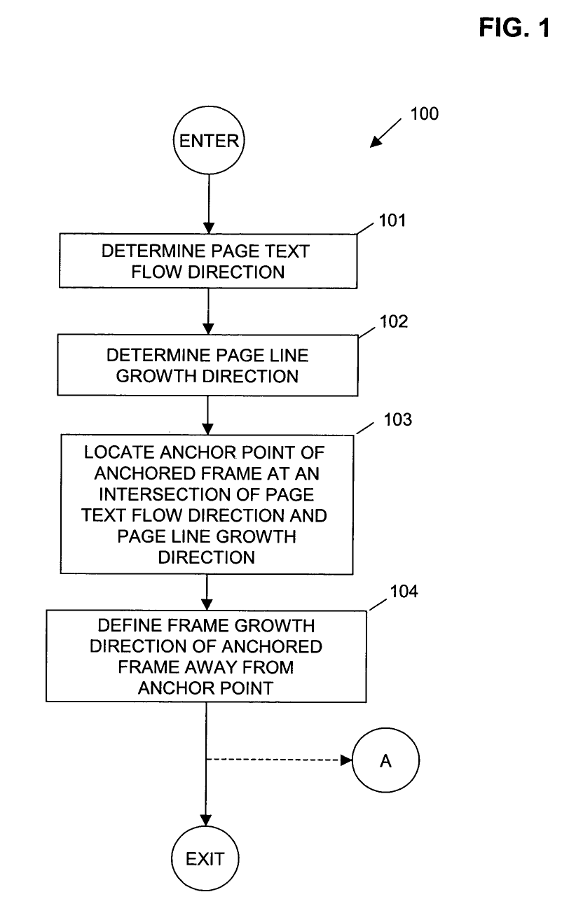

FIG. 1 illustrates a process flow diagram of a method 100 for defining an anchored frame in a page having text elements in accordance with one embodiment of the invention. FIGS. 2A and 2B illustrate elements of a system for defining an anchored frame in a page having text elements in accordance with one embodiment of the invention. In one embodiment, the arrangements of FIGS. 2A and 2B are adapted to execute the operations shown and described with reference to FIG. 1, however, FIGS. 2A and 2B are not limited thereto. Herein text elements include characters, symbols, spaces, images, auditory elements, or other representational forms. Further, herein for purposes of illustration a page is assumed to have two substantially parallel, vertical sides, e.g., left and right sides, and two substantially parallel, horizontal sides, e.g., top and bottom sides, within which text elements are entered.

Referring to FIGS. 1, 2A and 2B together, in one embodiment, in method 100, from a enter operation processing transitions to an operation 101.

In operation 101, a page text flow direction of a page is determined. Herein, the page text flow direction is the direction of sequentially arranging text elements, such as within a line on a page. For example, European writing styles, such as the English or German writing styles, sequentially arrange text elements in a line in a horizontal direction from a left side position on a page toward a right side position on the page, and, therefore, have a page text flow direction that is left to right. Particularly referring to FIG. 2A, a page text flow direction (PTFD) 216 illustrates a page text flow direction that is left to right, e.g., in a direction from the left side of page 210 toward the right side.

As a further example, the Japanese writing style sequentially arranges text elements in a line in a vertical direction from the top to the bottom of a page, and thus, the page text flow direction is vertically downward. Particularly referring to FIG. 2B, a page text flow direction (PTFD) 226 illustrates a page text flow direction that is vertically downward, e.g., from the top side of page 210 toward the bottom side.

In one embodiment, an initial page text flow direction is determined based on settings of a text application program. In other embodiments, a user operating a text processing application determines a page text flow direction in accordance with the user's preference.

To identify the page text flow direction, in one embodiment, direction settings of a corresponding text application program are determined. In other embodiments, the actual arrangement of text elements on a displayed page are determined. Upon a determination of the page text flow direction, operation 101 transitions processing to an operation 102.

In operation 102, a page line growth direction of the page is determined. Herein, the page line growth direction is the direction of a sequence of consecutive lines containing text elements. For example, with a left to right writing style, such as in the German and English writing styles, a page line growth direction is oriented downward on the page, as a subsequent line containing text elements is placed below the lines already present. Particularly referring to FIG. 2A, a page line growth direction (PLGD) 215 illustrates a page line growth direction that is oriented downward, e.g., from the top side of page 210 toward the bottom side.

In one embodiment, the page line growth direction is determined based on settings of a text application program. In other embodiments, the page line growth direction is determined based on the actual arrangement of text elements and lines on a displayed page. Upon a determination of the page line growth direction, operation 102 transitions processing to an operation 103.

In operation 103, in one embodiment, an anchor point of the anchored frame is located near an intersection of the page text flow direction and the page line growth direction. For example, in one embodiment, an intersection of the page text flow direction and the page line growth direction is a location where a first text element in a first line is positionable on the page, for example, near a text origin of the page.

By way of illustration, assume the page text flow direction is a field of parallel vectors in a direction of a sequence of text elements within a line on the page. The page line growth direction is a field of parallel vectors in a direction of subsequent lines of text elements on the page. An intersection of the page text flow direction and the page line growth direction is thus locatable at nearly any location on the page, as an arbitrary one of the vectors for the page text flow direction and an arbitrary one of the vectors of the page line growth direction determine an intersection.

For example, particularly referring to FIG. 2A, on a page with a European writing style having a left to right page text flow direction (PTFD) 216 and a page line growth direction (PLGD) 215 oriented vertically downward, an anchor point, such as anchor point (AP) 211 is locatable near an intersection of PTFD 216 and PLGD 215 in the upper left corner of page 210 or at another intersection location within page 210. In one embodiment, the intersection of the page text flow direction and the page line growth direction is determined based on settings of the text processing application, while in other embodiments, the determination of the intersection involves user interaction, such as user positioning or input.

In one embodiment, operation 103 is automatically performed, while in other embodiments, user interaction is needed, for example, a user arranging the anchor point on the page. In one embodiment, the anchor point is a marker stored in association with the page, e.g., in a digital representation of the page, such as a text document stored in the form of a file on a storage device.

In one embodiment, the anchor point is located near a text origin of the page. Herein, the text origin is defined as the position of the first text element on a page in accordance with a particular writing style. For example, a text origin in accordance with the European writing style is defined as the upper left corner of the page, such as AP 211 in FIG. 2A. Differently, a text origin in accordance with the Arabic writing style is defined as the upper right corner of the page. A text origin in accordance with the Japanese or Chinese writing styles is defined as the upper right corner. Upon location of the anchor point, operation 103 transitions processing to an operation 104.

In operation 104, a frame growth direction of the anchored frame is defined. Herein, a frame growth direction is defined as a direction of enlarging the anchored frame. In one embodiment, the frame growth direction is defined to be oriented away from the anchor point to reduce interference with the text elements of a page. Upon insertion of further text elements or based on a resizing command from a user, the frame grows at a side opposite from a side closest to the anchor point and in a direction oriented away from the anchor point to reduce interference with the text elements of the page as further described herein.

In one embodiment, the frame growth direction of the anchored frame is defined as the same direction as a frame text flow direction of the anchored frame or a direction opposite to a frame text flow direction of the anchored frame. Herein the frame text flow direction is the direction of a sequence of text elements in a line within the anchored frame.

In other embodiments, the frame growth direction is defined to have the same direction as a frame line growth direction or a direction opposite to the frame line growth direction. Herein the frame line growth direction is the direction of a sequence of lines of text elements within the anchored frame.

For example, in an anchored frame with a left to right frame text flow direction, such as in the German and English writing styles, a frame growth direction defined to have the same direction as the frame line growth direction is oriented vertically downward, e.g., from the top of the page toward the bottom of the page.

Defining the frame growth direction of the anchored frame as oriented away from the anchor point reduces interference with page text elements as the anchored frame does not grow in a direction opposite to a page text flow direction or a page line growth direction. This is particularly advantageous if, for example, vertical writing styles or right to left writing styles are used and/or combined with different types of writing styles.

Further, by directing the frame growth direction away from the anchor point (located near the intersection of the page text flow direction and the page line growth direction), a frame growth direction is determined to conform with a basic layout of the page, whether there is a particular writing style used in a page, or a combination of writing styles in a page and in an anchored frame.

In one embodiment, the anchored frame inherits, i.e., is defined to have, at least one of the page text flow direction and the page line growth direction from the page. In one embodiment, the anchored frame is defined based on the underlying page and is then modifiable, for example, upon a determination that the frame growth direction has a component in a direction opposite to at least one of the page line growth direction and page text flow direction. Upon definition of the frame growth direction of the anchored frame, from operation 104, processing exits method 100.

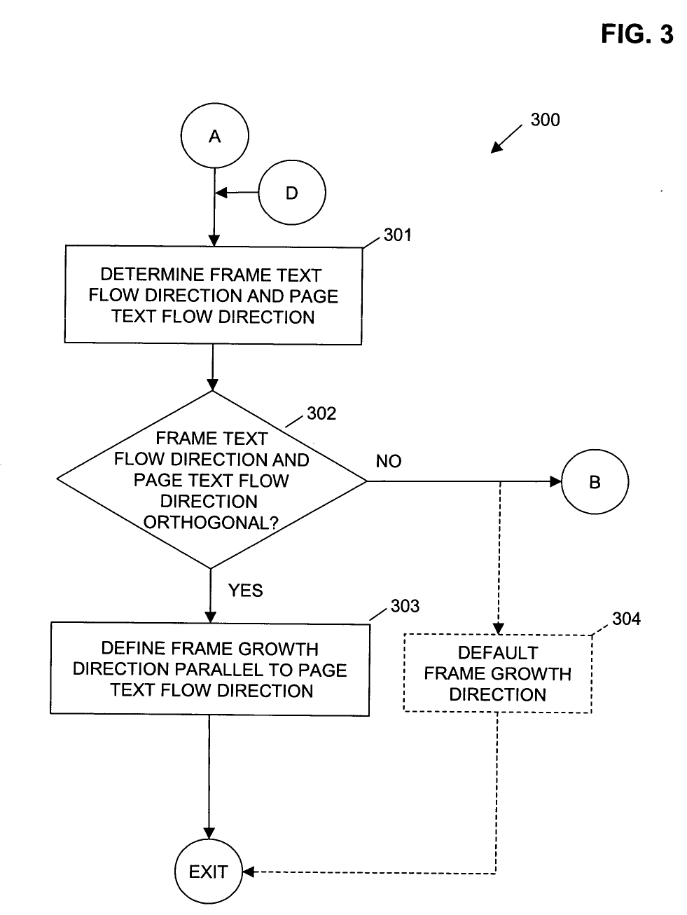

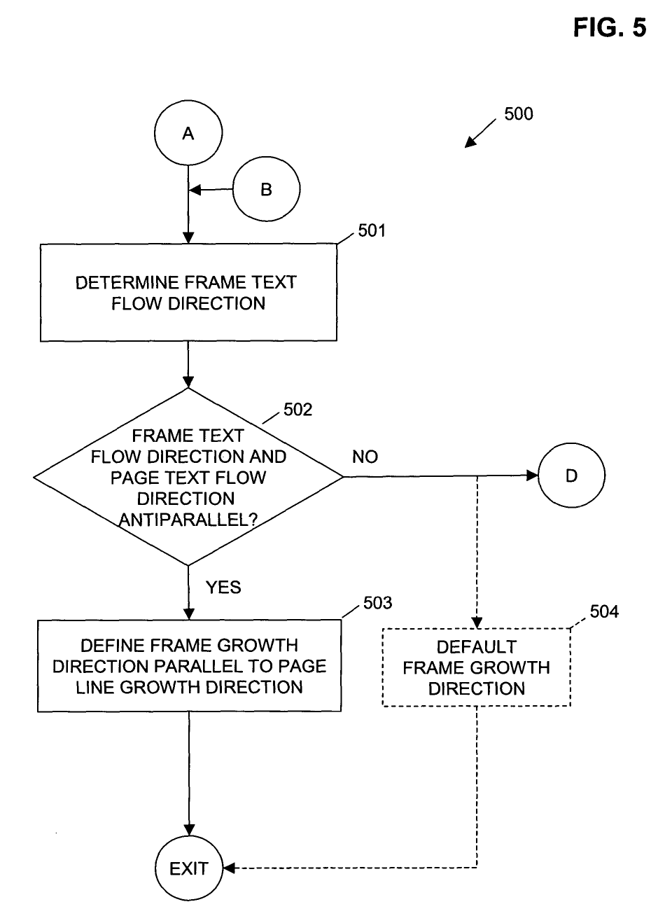

In some embodiments, optionally, from operation 104, processing exits method 100 at exit point A and transitions to further processing, such as further described herein with reference to FIGS. 3 and 5.

Referring particularly now to FIG. 2A, elements of a data processing unit 200 and an example of a page 210 generated by or for a text processing application in accordance with one embodiment of the invention are illustrated. In one embodiment, data processing unit 200 includes a page text flow direction and page line growth direction determiner 201. In one embodiment, the page text flow direction and the page line growth direction determiner 201 includes a means for determining a page text flow direction and a page line growth direction of the page. In one embodiment, the page text flow direction and the page line growth direction are defined as earlier described with reference to FIG. 1.

In one embodiment, data processing unit 200 further includes an anchor point locator 202. In one embodiment, anchor point locator 202 includes a means for locating an anchor point of an anchored frame near an intersection of the page text flow direction and the page line growth direction. In one embodiment, data processing unit 200 also includes a frame growth direction definer 203. In one embodiment, frame growth direction definer 203 includes a means for defining a frame growth direction of the anchored frame to be oriented away from the anchor point to reduce interference with the text elements of the page.

In one embodiment, a text processing application 204 is provided within data processing unit 200, as shown in FIG. 2A. However, in other embodiments, text processing application 204 is provided at an external location communicatively coupled with data processing unit 200. In one embodiment, page text flow direction and page line growth direction determiner 201, anchor point locator 202, and frame growth direction definer 203 are included within text processing application 204, while in other embodiments, they are maintained as separate functional entities assisting text processing application 204.

FIG. 2A also illustrates an example of page 210 displayed on a display unit 250 associated with data processing unit 200. Display unit 250 may be, for example, a cathode ray tube (CRT)-type display unit, or other display unit capable of displaying page 210. In one embodiment, page 210 is a page including text elements generated by text processing application 204, for example, under control by a user. In some embodiments, page 210 includes different portions with different writing styles. For clarity of description, however, in the present example, only one writing style on page 210 is illustrated.

In FIG. 2A, page 210 is illustrated having text elements written in accordance with the European writing style, i.e., having a page text flow direction (PTFD) 216 from left to right and a page line growth direction (PLGD) 215 oriented in a downward direction, i.e., lines are appended consecutively in direction from the top side of the page to the bottom side of the page. In FIG. 2A, in one embodiment, a first anchor point (AP) 211 is located in the upper left corner of page 210 near an intersection of page text flow direction 216 and page line growth direction 215. In one embodiment, anchor point 211, even though shown in FIG. 2A for illustration, is not displayed, yet is maintained for defining a position of an anchored frame. As shown in FIG. 2A, first anchor point 211 is located near the text origin of the page.

As illustrated, a first anchored frame (AF) 212 is associated with first anchor point 211, e.g., first anchored frame 212 is maintained in a fixed position and direction with reference to first anchor point 211 as further described herein. In the present embodiment, first anchored frame 212 is defined to have a frame growth direction(s) 217A and 217B oriented away from first anchor point 211 in a downward and a rightward direction, e.g., toward the bottom side of page 210 and toward the right side of page 210. In one embodiment, first anchored frame 212 grows in one of the frame growth direction(s) 217A and 217B, while in other embodiments, first anchored frame 212 grows in both of the frame growth directions 217A/B.

In one embodiment, frame growth direction(s) 217A and 217B is the same as the frame text flow direction of anchored frame 212, while in other embodiments the frame growth direction(s) 217A and 217B is the same as the frame line growth direction of first anchored frame 212. For example, in one embodiment, if first anchored frame 212 includes text elements having a vertical frame text flow direction (from top to bottom, or bottom to top), such as in the Japanese writing style, a frame growth direction 217i is oriented to the right, e.g., toward the right side of page 210, such as in the direction of frame growth direction 217A. In another embodiment, if first anchored frame 212 includes text elements having a horizontal frame text flow direction (from right to left or left to right), a frame growth direction 217i is oriented downward, e.g., toward the bottom side of page 210, such as in the direction of frame growth direction 217B.

In FIG. 2A, a second anchor point (AP) 213 is shown located near an intersection of page text flow direction 216 and page line growth direction 215, for example, such as by user positioning. A second anchored frame (AF2) 214 is associated with second anchor point 213, e.g., second anchored frame 214 is maintained in a fixed position and direction with reference to second anchor point 213. In one embodiment, second anchored frame 214 includes text elements in accordance with an existing writing style and has a frame growth direction(s) 218A/B, i.e., a direction of frame growth if further text elements are included, for example, in a downward direction, e.g., toward the bottom side of page 210, and/or a horizontal direction oriented to the right, e.g., toward the right side of page 210.

In the present embodiment, although two anchored frames are shown, i.e., first anchored frame 212 and second anchored frame 214, in other embodiments fewer or more anchored frames are possible. Additionally, in some embodiments anchored frames are anchored within other anchored frames.

In FIG. 2A, as first anchored frame 212 and second anchored frame 214 respectively have frame growth direction(s) 217A/B and 218A/B oriented away from first anchor point 211 and second anchor point 213 and from the text origin of page 210 and 220, an interference with an existing layout of page 210 and 220 is reduced. Further, in one embodiment, as frame growth direction(s) 217A/B and 218A/B are automatically determined based on a position of first anchor point 211 and second anchor point 213, respectively, and the parameters of underlying page 210, user interaction to define the parameters of first anchored frame 212 and second anchored frame 214 is reduced.

FIG. 2B shows an example of a page 220 and a third anchored frame (AF3) 222 generated and/or defined using data processing unit 200 of FIG. 2A in accordance with another embodiment of the invention. As shown in FIG. 2B, in one embodiment, page 220 includes text elements having a page text flow direction (PTFD) 226 in a downward direction, e.g., toward the bottom side of page 220, such as in the Chinese or Japanese writing styles. Further, page 220 has a page line growth direction (PLGD) 225 toward the left, e.g., toward the left side of page 220.

As illustrated, a third anchor point (AP) 221 is located near an intersection of page text flow direction 226 and page line growth direction 225. Third anchored frame (AF1) 222 is associated with third anchor point 221, e.g., third anchored frame 222 is maintained in a fixed position and direction with reference to third anchor point 221 as further described herein. In the present example, third anchor point 221 coincides with the text origin of page 220.

In FIG. 2B, a frame growth direction(s) 227A/B of third anchored frame 222 is defined oriented away from third anchor point 221 to reduce interference with an existing layout of page 220. In one embodiment, frame growth direction(s) 227A/B progresses in one of the directions shown in FIG. 2B. In other embodiments, frame growth direction(s) 227A/B progresses in both of the directions shown in FIG. 2B.

In one embodiment, if the text origin of a page is assumed to be close to a position of a first text element in a first line on page 220, such as in the upper right corner of page 220, the anchor point is assumed to be located closer to the text origin than the anchored frame, e.g., third anchor point 221 is located closer to the text origin than third anchored frame 222. This generates a more intuitive placing of anchored frames and anchor points on a page.

In other embodiments, it is possible that the anchored frame is located closer to a text origin of an underlying page than the anchor point. In these other embodiments, rather than defining a frame growth direction of the anchored frame to be oriented away from the anchor point, the frame growth direction is defined in a direction oriented away from the text origin.

In FIG. 2A, data processing unit 200 may be a general-purpose computer, a desktop computer, a laptop computer, a palmtop computer or any other kind of computing device, including personal digital assistant (PDU) and mobile communication devices such as mobile telephones. In some embodiments, data processing unit 200 further includes a central processing unit and a memory for storing required software programs.

In one embodiment, page text flow direction and page line growth direction determiner 201, anchor point locator 202, and frame growth direction definer 203 are embodied as a sequence of coded instructions for execution on a central processing unit (not shown) of data processing unit 200, and in some embodiments, are at least partially implemented as hardware components.

In one embodiment, coded instructions for executing the functionality of page text flow direction and page line growth direction determiner 201, anchor point locator 202, frame growth direction definer 203 and/or text processing application 204 are stored in a storage unit 260, such as a memory structure, provided within data processing unit 200, as shown in FIG. 2A. In some embodiments, storage unit 260 is located at an external location accessible by data processing unit 200, such as via a communication link.

In one embodiment, text processing application 204 is embodied as a sequence of coded instructions provided at data processing unit 200 for handling a text document and/or for generating the layout of a text document, as described above. In some embodiments, the coded instructions are also stored in a storage unit, such as storage unit 260, and are retrieved by the central processing unit of data processing unit 200 on demand. Moreover, in one embodiment, text processing application 204, page text flow direction and page line growth direction determiner 201, anchor point locator 202, and frame growth direction definer 203 form a single application module for a group of related application modules.

In some embodiments, text processing application 204 is located at a remote location, e.g., on a different data processing unit communicatively couple with data processing unit 200.

In one embodiment, a program or a group of programs are provided having instructions adapted to cause a data processing device, such as data processing unit 200, or a group of data processing devices to carry out at least one of the above described operations of method 100. Further, in one embodiment, a computer readable medium is provided, in which a program is embodied, and the program causes a computer to execute at least one of the operations of method 100.

Herein, a computer-readable medium is a magnetic or optical or other tangible medium on which a program is embodied, but can also be a signal, e.g., analog or digital, electronic, magnetic or optical, in which the program is embodied for transmission. Further, in some embodiments, a data structure or a data stream is provided including instructions to cause a data processing means, such as data processing unit 200, to carry out the above described operations of method 100. In one embodiment, the computer readable medium is embodied by the data stream or the data structure. In one embodiment, a computer program product is provided comprising the computer-readable medium.

FIG. 3 illustrates a process flow diagram of a method 300 for defining an anchored frame in a page having text elements in accordance with another embodiment of the invention. More particularly, in one embodiment, FIG. 3 describes operations for defining an anchored frame in the presence of a vertical writing direction in at least one of a frame and a page.

Referring now to FIGS. 1-3 together, in one embodiment, method 300 is entered from method 100 at an entry point A corresponding to an exit point A shown in FIG. 1. In one embodiment, method 300 is performed subsequent to operations 101-104 of method 100, however, method 300 is not limited thereto. From entry point A, processing transitions to an operation 301.

In operation 301, a page text flow direction of a page and a frame text flow direction of an anchored frame are determined, e.g., as earlier described with reference to method 100 and FIGS. 1, 2A and 2B. Upon determination of the frame text flow direction and the page text flow direction, operation 301 transitions processing to an operation 302.

In operation 302, a determination is made whether the page text flow direction and the frame text flow direction are orthogonal to one another. In one embodiment, the determination whether the page text flow direction and the frame text flow direction are orthogonal to one another is made by comparing corresponding settings defined in association with the page and the anchored frame.

For example, in one embodiment, the page text flow direction is determined in association with a user preference and, the frame text flow direction is defined based on default settings for anchored frames, such as based on user preferences. Upon a determination that the page text flow direction and the frame text flow direction are orthogonal to one another (“YES”), operation 302 transitions processing to an operation 303.

In operation 303, the frame growth direction is defined to have the same direction, e.g., a parallel direction, as the page text flow direction. This may be particularly advantageous, if vertical and horizontal writing styles are combined with one another. Upon definition of the frame growth direction, from operation 303, processing exits method 300 at an exit operation.

Referring again to operation 302, upon a determination that the page text flow direction and the frame text flow directions are not orthogonal to one another (“NO”), in one embodiment, from operation 302, processing exits method 300 at exit point B, for example, to transition to other processing such as further described herein with reference to FIG. 5.

Optionally, upon a determination in operation 302 that the page text flow direction and the frame text flow directions are not orthogonal (“NO”), operation 302 transitions processing to an operation 304.

In optional operation 304, a default frame growth direction is determined. In one embodiment, the default frame growth direction is a preset frame growth direction for anchored frames. In one embodiment, the default frame growth direction is determined based on a frame line growth direction of the frame. In one embodiment, the default frame growth direction is determined based on a page line growth direction of the page. Upon determination of the default frame growth direction, from optional operation 304, processing exits method 300 at an exit operation.

In one embodiment, a data processing device, such as data processing unit 200 of FIG. 2A, is provided including a means for determining whether a page text flow direction of a page and a frame text flow direction of an anchored frame are orthogonal to one another, and, in this embodiment, for defining the frame growth direction of the anchored frame to have the same direction as the page text flow direction of the page. In one embodiment, the means for determining whether a page text flow direction of a page and a frame text flow direction of an anchored frame are orthogonal to one another is embodied as a sequence of coded instructions for execution on a central processing unit of data processing unit 200 and/or are at least partially implemented as hardware components.

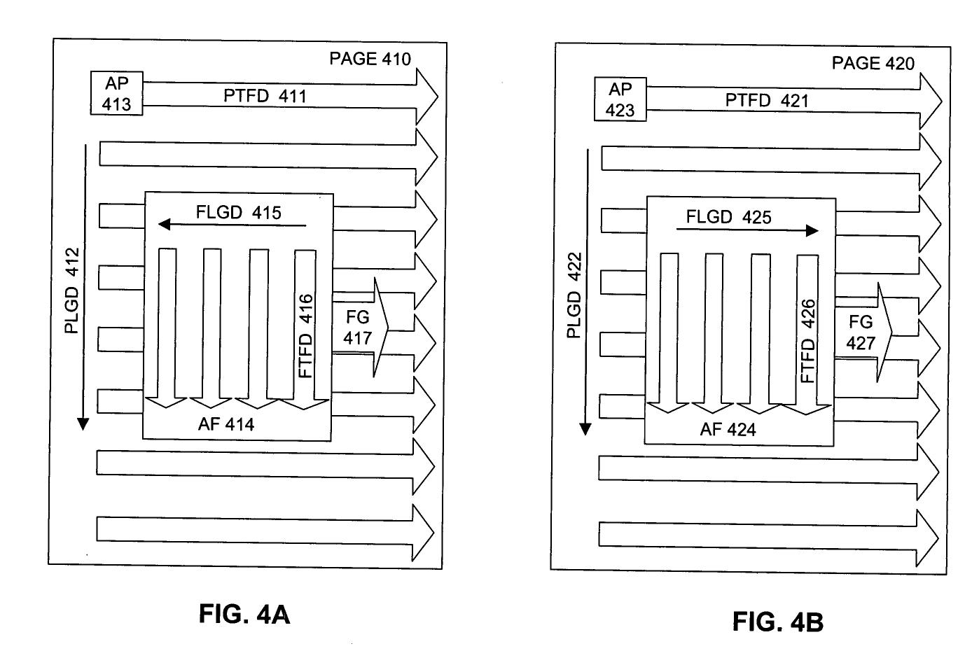

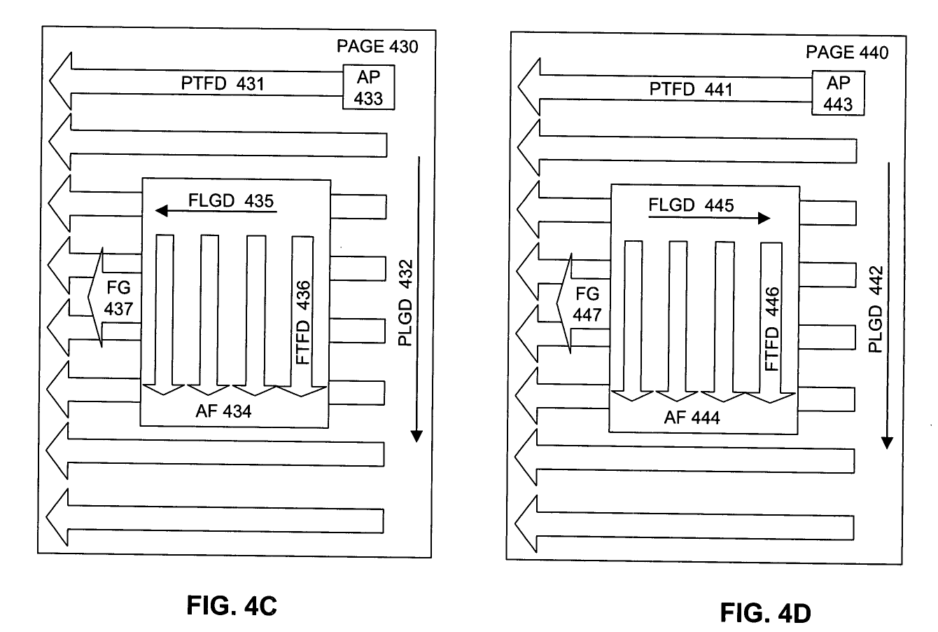

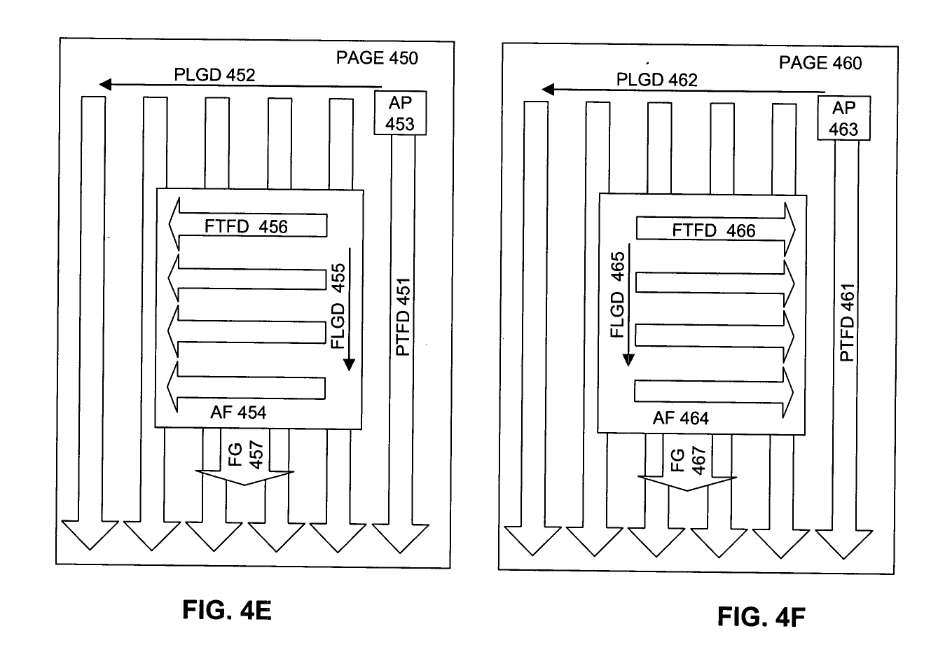

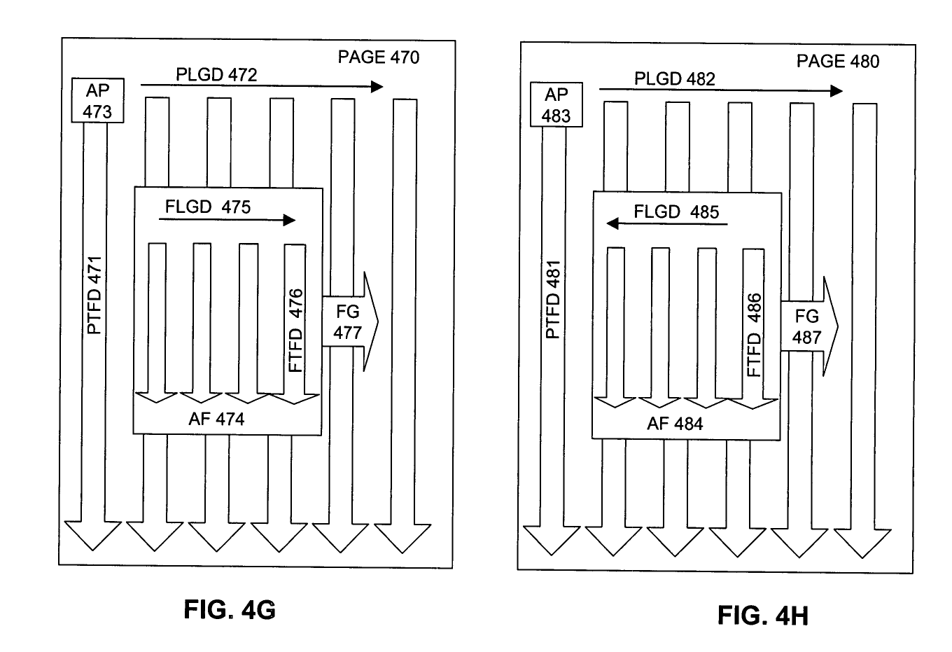

FIGS. 4A-4H each illustrate an example of a page generated by or for a text processing application in accordance with embodiments of the invention. In one embodiment, the pages and anchored frames of FIGS. 4A-4H are generated using method 300, however the embodiments are not limited thereto. In one embodiment, method 300 and the examples of FIGS. 4A-4H are generated utilizing the system of FIG. 2A (including data processing unit 200), however, FIG. 3 and the generation of the examples of FIGS. 4A-4H are not limited thereto. FIGS. 4A-4H each show an example of defining a frame growth direction of an anchored frame in accordance with a page text flow direction and a page line growth direction of an underlying page.

FIG. 4A illustrates an example of a page 410 having an anchored frame defined in accordance with one embodiment of the invention. In the present embodiment, page 410 includes text having a page text flow direction 411 in a horizontal left to right direction. Further, page 410 has a page line growth direction (PLGD) 412 in a downward direction, e.g., toward the bottom of page 410, such as in the German or English writing styles.

In one embodiment, an anchor point 413 is located near the text origin of page 410, i.e., near an intersection of page text flow direction (PTFD) 411 and page line growth direction 412. However, in other embodiments, anchor point (AP) 413 is locatable at other intersections within page 410. An anchored frame 414 is located as shown in page 410 and has a frame text flow direction (FTFD) 416 in a downward direction, e.g., from the top to the bottom, such as in the Japanese or Chinese writing styles.

Accordingly, text elements are arranged beginning from a text origin in the upper right corner of anchored frame 414 and progressing in a downward oriented direction. A frame line growth direction (FLGD) 415 of anchored frame 414 is oriented toward the left (in the plane of the drawing) such that consecutive columns, e.g., lines, including text elements are arranged parallel to one another toward the left side of page 410. Further, a frame growth direction (FG) 417 of anchored frame 414 is defined in a direction away from anchor point 413.

Thus, even though intuitively the frame growth direction in the present example would be toward the left, as consecutive columns including text elements are appended toward the left in frame line growth direction 415, frame growth direction 417 is defined oriented to the right to reduce interference with an existing layout of page 410.

FIG. 4B shows an example of a page 420 with a page text flow direction (PTFD) 421 from left to right and a page line growth direction (PLGD) 422 in a direction oriented downward, e.g., toward the bottom of page 420. An anchor point (AP) 423 coincides with the text origin of page 420.

As illustrated in FIG. 4B, an anchored frame 424 has a frame text flow direction (FTFD) 426 in a downward direction, such as in a vertical writing style. A frame line growth direction (FLGD) 425 is oriented toward the right with the first text element of anchored frame 424 located near the upper left corner, and the text origin of anchored frame 424 near the upper left corner in anchored frame 424, such as in the Mongolian writing style (columns of text elements are placed consecutively in a direction toward the right of page 420). In the example of FIG. 4B, a frame growth direction (FG) 427 is defined in a direction away from the anchor point 423/text origin toward the right of page 420.

FIG. 4C shows a page 430 with a page text flow direction (PTFD) 431 in a right to left direction, and a page line growth direction (PLGD) 432 oriented in a downward direction, e.g., toward the bottom of page 430. An anchor point (AP) 433 is located near an intersection of page line growth direction 432 and page text flow direction 431. Anchor point 433 is assumed to coincide with the text origin of page 430. An anchored frame 434 has a frame text flow direction (FTFD) 436 in a downward direction and a frame line growth direction (FLGD) 435 toward the left of page 430, such as in the Japanese and Chinese writing styles. In FIG. 4D, a frame growth direction (FG) 437 of anchored frame 434 is defined in a direction away from anchor point 433 (and the text origin) in a direction toward the left of page 430.

FIG. 4D shows an example of a page 440 with a page text flow direction (PTFD) 441 in a right to left direction on page 440, such as in the Arabic writing style. Further, page 440 has a page line growth direction (PLGD) 442 in a downward direction and an anchor point (AP) 443 located near the text origin, i.e., near an intersection of page line growth direction 442 and page text flow direction 441.

An anchored frame 444 with has a frame line growth direction (FLGD) 445 toward the right and a frame text flow direction (FLGD) 446 in the downward direction, such as in the Mongolian writing style. In FIG. 4D, a frame growth direction (FG) 447 of anchored frame 444 is defined in a direction away from anchor point 443 (and the text origin) in a direction toward the left of page 440.

FIG. 4E shows an example of a page 450 with a page text flow direction (PTFD) 451 in a downward direction, such as in the Chinese or Japanese writing styles. Further, page 450 has a page line growth direction (PLGD) 452 oriented toward the left of page 450. An anchor point (AP) 453 is located near the text origin, i.e., near an intersection of page line growth direction 452 and page text flow direction 451. An anchored frame (AF) 454 has a frame line growth direction (FLGD) 455 in a downward direction and a frame text flow direction (FTFD) 456 in a right to left direction in page 450, such as in the Arabic writing style. In FIG,. 4E, the frame growth direction (FG) 457 is defined in a direction away from anchor point 453, in a downward direction.

FIG. 4F shows an example of a page 460 having a page text flow direction (PTFD) 461 oriented in a downward direction, such as in the Chinese and Japanese writing styles. Further, page 460 has a page line growth direction (PLGD) 462 oriented toward the left of page 460. An anchor point (AP) 463 is defined near an intersection of page line growth direction 462 and page text flow direction 461.

An anchored frame (AF) 464 associated with anchor point 463 has a frame line growth direction (FLGD) 465 oriented in a downward direction and a frame text flow direction (FTFD) 466 oriented toward the right of page 460, such as in the German and English writing styles. In FIG. 4F, the frame growth direction (FG) 467 of anchored frame 464 is oriented in a direction away from anchor point 463 in a downward direction, e.g., toward the bottom of pate 460.

FIG. 4G shows an example of a page 470 having a page text flow direction (PTFD) 471 oriented in a downward direction and a page line growth direction (PLGD) 472 oriented toward the right of page 470, such as in the Mongolian writing style. An anchor point (AP) 473 is located near an intersection of page line growth direction 472 and page text flow direction 471, and is located near the text origin of page 470.

An anchored frame (AF) 474 has a frame line growth direction (FLGD) 475 toward the right of page 470 and a frame text flow direction (FTFD) 476 in a downward direction, such as in the Mongolian writing style. In FIG. 4G, a frame growth direction (FG) 477 is defined in a direction toward the right of page 470, in a direction away from anchor point 473.

FIG. 4H shows an example of a page 480 having a page text flow direction (PTFD) 81 in a downward direction and a page line growth direction (PLGD) 482 oriented toward the right of page 480, such as in the Mongolian writing style. An anchor point (AP) 483 is located near an intersection of page line growth direction (PLGD) 482 and page text flow direction (PTFD) 481 and located near the text origin of page 480.

An anchored frame (AF) 484 has a frame line growth direction (FLGD) 485 oriented toward the left of page 480, and a frame text flow direction (FTFD) 486 in a downward direction, such as in the Chinese and Japanese writing styles. In FIG. 4H, a frame growth direction (FG) 487 is oriented away from anchor point 483 and in a direction toward the right of page 480.

In the examples shown and described with reference to FIGS. 4A-4H, the frame growth direction is defined in a direction away from the anchor point and generally includes multiple directions, e.g., vertically oriented (parallel with the right and left sides of the page) or horizontally oriented (parallel with the top and bottom sides of the page). In some embodiments, the frame growth direction is defined in the same direction as the frame line growth direction of the anchored frame. In instances where it is not desirable to define the frame growth direction in the same direction as the frame line growth direction of the anchored frame, i.e., in a direction toward the anchor point, in some embodiments, the frame growth direction is defined in a direction opposite to the frame line growth direction of the anchored frame.

In some embodiments, the frame growth direction is defined in the same direction as the frame text flow direction of the anchored frame, while in other embodiments, the frame growth direction is defined in a direction opposite to the frame text flow direction of the anchored frame. In some embodiments, the frame growth direction is defined in a direction away from a text origin of the page.

FIGS. 4A-4H illustrate several examples of defining a frame growth direction in the presence of different writing styles in a page and/or an anchored frame. Herein, although FIGS. 4A-4H are illustrated as separate examples, in some embodiments, any, some or all of the FIGS. 4A-4H may be combined with one another, for example, in some embodiments, different page text flow directions and page line growth directions are combined and utilized with various anchored frames.

FIG. 5 illustrates a process flow diagram of a method 500 for defining an anchored frame in a page having text elements in accordance with another embodiment of the invention. More particularly, in one embodiment, FIG. 5 describes operations for defining an anchored frame in the presence of a page text flow direction that is opposite to a frame text flow direction.

Referring now to FIGS. 1 and 5 together, in one embodiment, method 500 is entered from method 100 at an entry point A corresponding to an exit point A shown in FIG. 1. In one embodiment, method 500 is performed subsequent to operations 101-104 of method 100, however method 500 is not limited thereto. For example, in other embodiments, method 500 is implemented in parallel to method 100.

Further, in some embodiments, method 500 is entered from method 300 at an entry point B corresponding to an exit point B shown in FIG. 3. In one embodiment, method 500 is performed subsequent to operations 301 and 302 of method 300, however method 500 is not limited thereto. For example, in other embodiments, method 500 is implemented in parallel to method 300. Thus, from entry point A or B, processing transitions to an operation 501.

In operation 501, a frame text flow direction of an anchored frame and a page text flow direction of a page are determined as earlier described with reference to FIGS. 1, 2A and 2B. Thus, in one embodiment, the frame text flow direction is determined based on a user input, while in other embodiments, the frame text flow direction is determined based on a user default setting and/or inherited. Upon a determination of the frame text flow direction of the anchored frame, operation 501 transitions processing to an operation 502.

In operation 502, a determination is made whether the page text flow direction and the frame text flow direction have opposing directions, i.e., are antiparallel. For example, if an anchored frame with a right to left frame text flow direction, such as in the Arabic writing style, is inserted into a page with a left to right page text flow direction, such as in the European writing style, the frame text flow direction of the anchored frame is in an opposing direction to the page text flow direction. Upon a determination that the page text flow direction and the frame text flow direction are opposing (“YES”), i.e., antiparallel, operation 502 transitions processing to an operation 503.

In operation 503, in one embodiment, the frame growth direction of the anchored frame is defined to have the same direction as the page line growth direction of the page. Thus, interference between the growing anchored frame with the layout of the page is reduced.

In one embodiment, the frame growth direction of the anchored frame is automatically defined to have the same direction as the page line growth direction of the page, such that minimum user interaction is required. Upon definition of the frame growth direction, from operation 503, processing exits method 500 at an exit operation.

Referring again to operation 502, optionally, in some embodiments, upon a determination that the page text flow direction and the frame text flow direction are not antiparallel, e.g., are not opposite to one another (“NO”), in one embodiment, from operation 502, processing exits method 500 at exit point D and transitions to other processing, such as earlier described with reference to FIG. 3 and method 300.

For example, upon entry to method 300 at entry point D, at operation 301 a determination is made whether the page text flow direction and the frame text flow direction of the anchored frame are orthogonal to one another. In one embodiment, upon a determination that the page text flow direction and the frame text flow direction are orthogonal to one another, the frame growth direction of the anchored frame is defined to have the same direction as the page text flow direction of the page, and processing exits method 300 (500). Alternatively, upon a determination that the page text flow direction and the frame text flow direction are not orthogonal to one another, the default frame growth direction is used, and processing exits method 300 (500).

Referring again to operation 502, in some embodiments, upon a determination that the page text flow direction and the frame text flow direction are not opposing (“No”), in one embodiment, optionally, operation 502 transitions processing to an optional operation 504.

In optional operation 504, in one embodiment, a default frame growth direction is determined. In one embodiment, the default frame growth direction is a preset frame growth direction for anchored frames, such as based on a user setting. In other embodiments, a user is prompted to define a frame growth direction, and the default frame growth direction is a frame growth direction based upon the user's selection. Upon determination of the frame growth direction, from optional operation 504, processing exits method 500 at an exit operation.

In one embodiment, the operations of method 500 are carried out using a data processing device, such as data processing unit 200. For example, in one embodiment, data processing unit 200 includes a means for determining whether the page text flow direction and the frame text flow direction of the anchored frame are opposite to one another and to define the frame growth direction of the anchored frame to have the same direction as the page line growth direction of the page. In one embodiment, the means for determining is embodied as a sequence of coded instructions for execution on a central processing unit of data processing unit 200 and/or are at least partially implemented as hardware components.

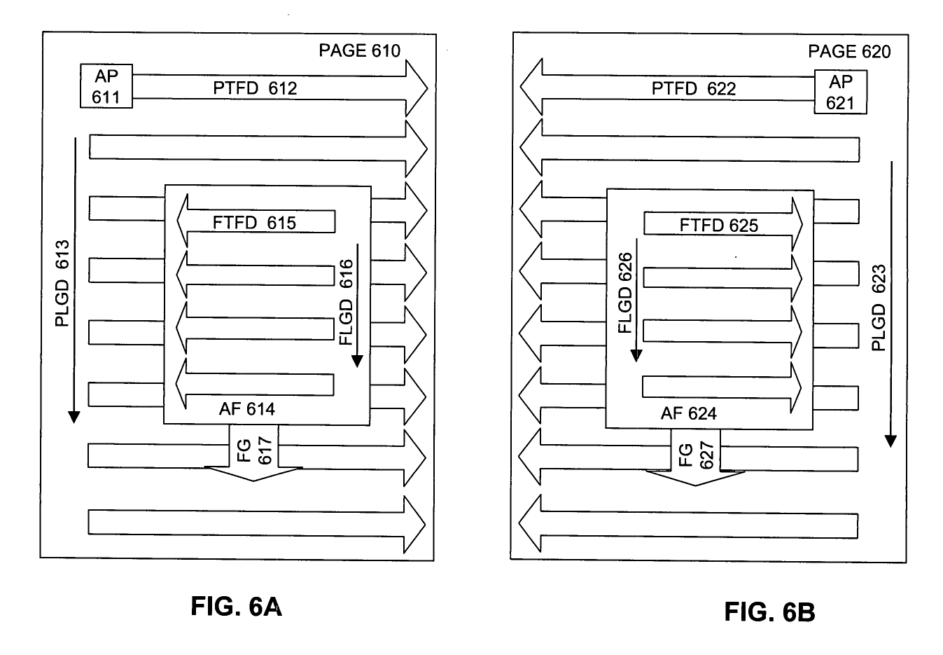

FIGS. 6A and 6B illustrate examples of defining an anchored frame in a page when the page text flow direction and the frame text flow direction of the anchored frame are opposite to one another in accordance with another embodiment of the invention. Referring now to FIGS. 1, 6A and 6B together, in one embodiment, the arrangements shown in FIGS. 6A and 6B are controlled using a data processing unit, such as the data processing unit 200, suitably modified to determine whether a page text flow direction of a page and a frame text flow direction of an anchored frame are opposite to one another. In one embodiment, upon a determination that the page text flow direction and the frame text flow direction are opposite to one another, the frame growth direction of the anchored frame is defined to have the same direction as the page line growth direction.

FIG. 6A shows a page 610 including a page text flow direction (PTFD) 612 in a left to right horizontal direction, such as in the European writing style. Further, page 610 has a page line growth direction (PLGD) 613 in a downward direction, such as in the European writing style. That is, text elements are arranged from an upper left corner of page 610 toward the right side of page 610 in lines and consecutive lines are arranged below one another in a downward direction, e.g., toward the bottom of page 610.

In FIG. 6A, an anchor point (AP) 611 is located near the text origin of page 610, i.e., near an upper left corner of page 610. An anchored frame (AF) 614 has a frame text flow direction (FTFD) 615 in a right to left horizontal direction in page 610 and a frame line growth direction (FLGD) 616 in a downward direction, such as in the Arabic writing style. Accordingly, in one embodiment, anchored frame 614 includes text or information in the Arabic writing style, inserted within a page in the European writing style.

Thus, in the present illustration of FIG. 6A, page text flow direction 612 and frame text flow direction 615 are opposite to one another. In one embodiment, a frame growth direction (FG) 617 of anchored frame 614 is defined to have the same direction as page line growth direction 613, i.e., in a downward direction. Accordingly, frame growth direction 617 of anchored frame 614 is oriented away from anchor point 611 and/or the text origin of page 610 in a downward direction toward the bottom of page 610.

FIG. 6B shows another example of defining an anchored frame in a page when the page text flow direction and the frame text flow direction of the anchored frame are opposite to one another in accordance with another embodiment of the invention. In FIG. 6B, in one embodiment, a page 620 has a page text flow direction (PTFD) 622 in a horizontal direction from right to left, such as in the Arabic writing style, and a page line growth direction (PLGD) 623 in a downward direction, e.g., toward the bottom of page 620. An anchor point (AP) 621 is located near the text origin of page 620, i.e., near the position of a first text element placed near the upper right corner of page 620.

In FIG. 6B, an anchored frame (AF) 624 has a frame text flow direction (FTFD) 625 in the horizontal direction from left to right and a frame line growth direction (FLGD) 626, oriented in the downward direction, such as in the European writing style. As page text flow direction 622 is opposite from frame text flow direction 625, a frame growth direction (FG) 627 of anchored frame 624 is defined to have the same direction as page line growth direction 623 of page 620 and is oriented away from anchor point 621 in a downward direction toward the bottom of page 620.

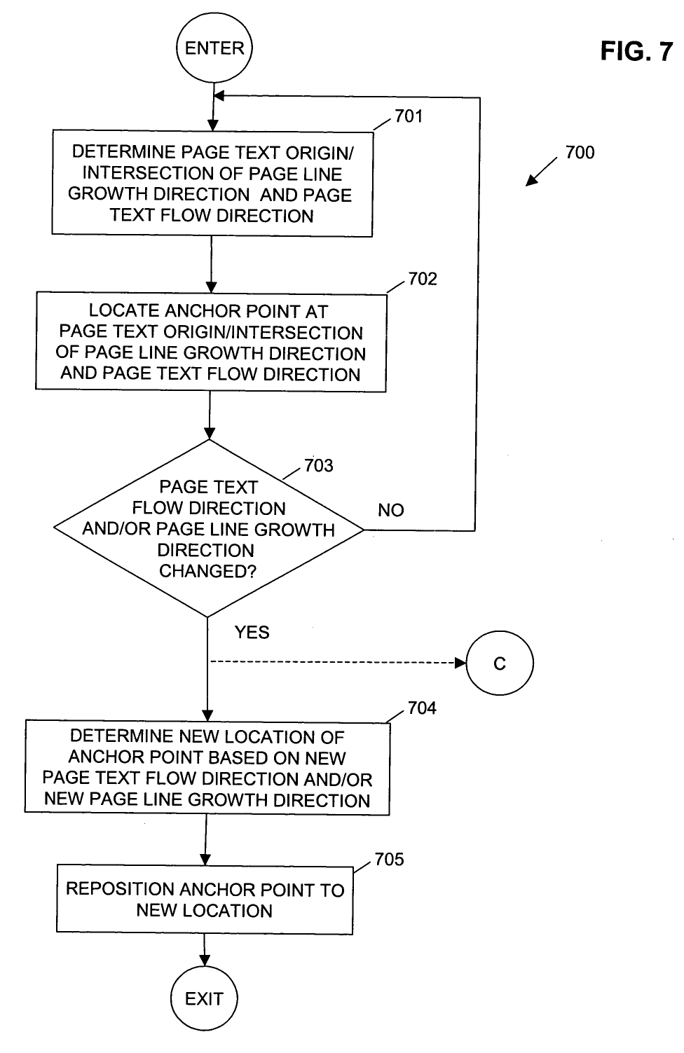

FIG. 7 illustrates a process flow diagram of a method 700 for defining an anchored frame in a page having text elements in accordance with another embodiment of the invention. More particularly, in one embodiment, FIG. 7 describes operations for defining an anchored frame upon changes to the writing style of the underlying page. In the embodiment of FIG. 7, it is assumed that an anchored frame is present in a page and that a page text flow direction and/or page line growth direction is changed, for example, in accordance with a user command.

In FIG. 7, in one embodiment, method 700 is entered from a enter operation, and processing transitions to an operation 701. In operation 701, a text origin of the page or a location for an anchor point near an intersection of a page line growth direction and a page text flow direction is determined, for example, as earlier described with respect to previous embodiments, such as by user interaction or predefined rules or settings. Upon determination of a text origin or location for an anchor point, operation 701 transitions processing to an operation 702.

In operation 702, an anchor point of an anchored frame is located near the determined text origin or near the determined intersection of the page line growth direction and page text flow direction. Upon determination of the anchor point, operation 702 transitions processing to an operation 703.

In operation 703, a determination is made whether the page text flow direction and/or the page line growth direction has changed, such as by a user changing the layout of the page. For example, a user controlling a text processing application may rearrange portions of a text document and change certain page parameters to adapt the layout of a page of the text document. Upon a determination that the page text flow direction and/or the page line growth direction has not changed (“NO”), operation 703 transitions processing to the start of method 700.

Alternatively, upon a determination that the page text flow direction and/or the page line growth direction has changed (“YES”), operation 703 transitions processing to an operation 704.

In operation 704, a new location of the anchor point is determined based on the new page text flow direction and/or the new page line growth direction. Thus, if one or both of the page text flow direction and page line growth direction are changed, a new text origin or intersection of page line growth direction and page text flow direction is determined, and operation 704 transitions processing to an operation 705.

In operation 705, the anchor point is repositioned to the determined new location, i.e., the new text origin or determined new intersection of the page line growth direction and the page text flow direction. For example, assume a writing style of a page before a change was left to right, such as in the European writing style, the text origin is located near the upper left corner of the page. Further, assume the page writing style is changed to right to left, such as in the Arabic writing style. Accordingly, the text origin is now located in the upper right corner of the page, and, in one embodiment, the anchor point is relocated in accordance therewith. Upon repositioning the anchor point to the new location, from operation 705, processing exits method 700 at an exit operation.

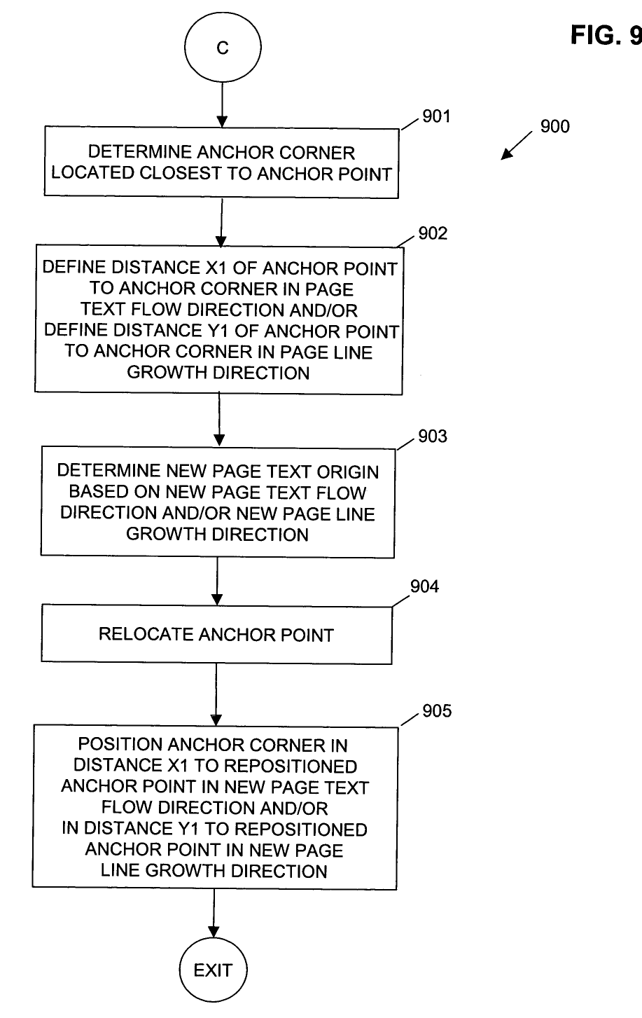

Referring again to operation 703, in some embodiments, optionally, upon a determination that the page text flow direction and/or the page line growth direction has changed (“YES”), from operation 703, processing transitions at exit point C to other processing in which the frame growth direction of the anchored frame is redefined based on the new location of the text origin/anchor point, such as further described herein with reference to FIG. 9. In one embodiment, the frame growth direction is re-determined so that it is oriented away from the new text origin/anchor point.

In one embodiment, a data processing device, such as data processing unit 200 executes the operations shown in FIG. 7. In one embodiment, data processing unit 200 includes a means for locating the anchor point near the text origin of the page and a means for determining a new location of the anchor point based on a new page text flow direction and a new page line growth direction, if at least one of the page text flow direction and the page line growth direction are changed. Further, in some embodiments, data processing unit 200 includes a means for repositioning the anchor point to the determined new location. Thus, the parameters of the anchored frame, specifically the frame growth direction, are determined based on the new anchor point/text origin so as to reduce interference with the layout of the page.

In one embodiment, the means for locating the anchor point near the text origin of the page and/or the means for determining a new location of the anchor point and/or the means for repositioning the anchor point to the determined new location are embodied as a sequence of coded instructions for execution on a central processing unit of data processing unit 200 and/or are at least partially implemented as hardware components.

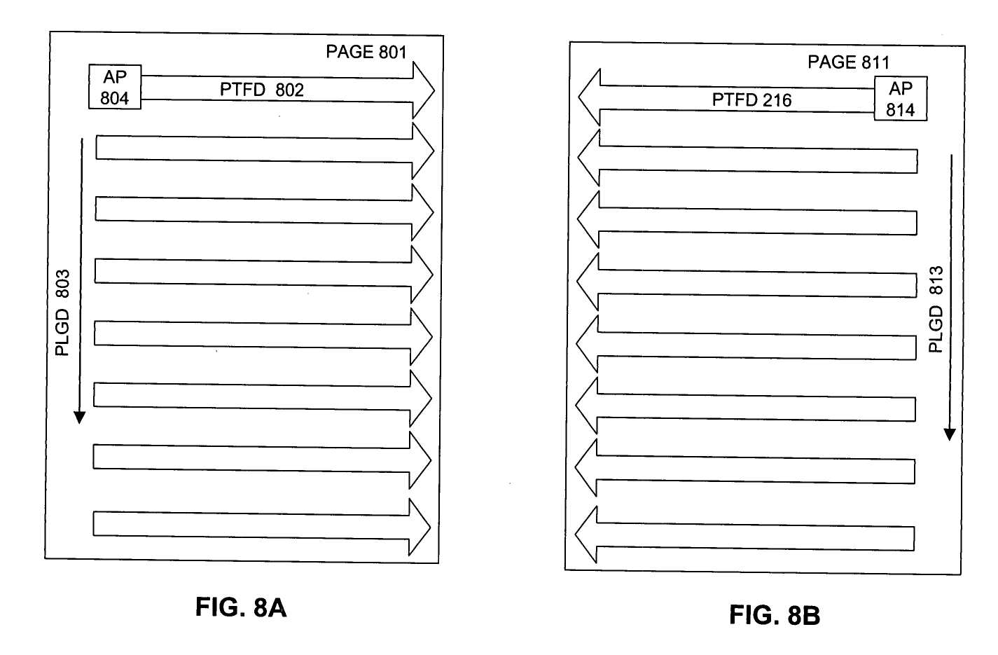

FIGS. 8A and 8B illustrate relocating an anchor point based on a change of the writing style of a page in accordance with another embodiment of the invention. Referring now to FIGS. 7, 8A and 8B together, in FIG. 8A, in one embodiment, a page 801 is illustrated with a horizontal writing style having a page text flow direction (PTFD) 802 from left to right and a page line growth direction (PLGD) 803 oriented in a downward direction, e.g., toward the bottom side of page 801, such as in the European writing style. An anchor point/text origin (AP) 804 is accordingly located near the upper left corner of the page, i.e., near a location for a first text element in a first line on page 801.

In the present embodiment, it is assumed that the writing style of page 801 is subsequently changed, as illustrated in a page 811 in FIG. 8B. Following the changes to the writing style, page 811 is has a new writing style from right to left with a page text flow direction (PTFD) 812 from right left, such as in the Arabic writing style. Further, a page line growth direction (PLGD) 813 is in a downward direction, e.g., toward the bottom side of page 811.

In accordance with the changes to the page text flow direction from left to right to right to left, in one embodiment, the anchor point/text origin is relocated as an anchor point (AP) 814 in the upper right corner of page 811, for example, to the location of the first text element in a first line in page 811 after the changes. Automatically relocating the anchor point to a suitable location as described with respect to FIGS. 7, 8A and 8B reduces user interaction during parameter changes to the page.

FIG. 9 illustrates a process flow diagram of a method 900 for defining an anchored frame in a page having text elements in accordance with another embodiment of the invention. More particularly, in one embodiment, FIG. 9 describes operations for relocating an anchored frame when parameters of a page underlying the anchored frame are changed, such as by user interaction. In one embodiment, the operations of method 900 are carried out following the operations earlier described with regard to FIG. 5 and/or FIG. 7. However, in other embodiments, method 900 is implemented as a separate process or in combination with other methods described herein.

Referring now to FIGS. 7 and 9 together, in one embodiment, method 900 is entered from method 700 at an entry point C corresponding to an exit point C shown in FIG. 7. In one embodiment, method 900 is performed subsequent to operations 701-703 of method 700, however method 900 is not limited thereto. For example, in other embodiments, method 900 is implemented in parallel to method 700. Upon entering method 900, from entry point C, processing transitions to an operation 901.

In operation 901, in one embodiment, an anchor corner of an anchored frame located closest to an anchor point is determined. In the present embodiment, the anchored frame is rectangular and thus has four corners, one of which is located closest to an anchor point associated with the anchored frame. For example, if an anchor point is located near the text origin of a page, assuming a page having text with a European writing style, the anchor point is located on the upper left corner of the page.

Further, assuming the anchored frame is located near a location in the page, the upper left corner of the anchored frame is located closest to the anchor point and is thus, the anchor corner of the anchored frame. Although the present embodiment is herein described with reference to a rectangular anchored frame, in other embodiments, differently shaped anchored frames are usable. Upon a determination of the anchor corner, operation 901 transitions processing to an operation 902.

In operation 902, a distance X1 and/or a distance Y1 are defined. In one embodiment, distance X1 is defined as the distance from the anchor point to the anchor corner in the page text flow direction. In one embodiment, distance Y1 is defined as the distance from the anchor point to the anchor corner in the page line growth direction. In one embodiment, to achieve scalability, the distance X1 and/or distance Y1 are determined dependent upon an actual size of the page, for example, as actually shown on a print out of the page and anchored frame. Thus, in one embodiment, both distance X1 and distance Y1 are determined based on the anchor point.

In an alternative embodiment, if only one of distance X1 or distance Y1 are to be maintained in relation to the anchor point, in operation 902, only one of the distance X1 and the distance Y1 are determined. For example, in one embodiment, one of the distance X1 or the distance Y1 is defined via other criteria. A horizontal or a vertical position of the anchored frame could be centered, left justified, right justified, associated with an upper or lower boundary of the page, etc. Thus, the anchor frame is maintained a determined distance X1 or distance Y1 to the anchor point, e.g., in a horizontal or a vertical direction, whereas the other parameter defining the position of the anchor frame, e.g., the other one of the horizontal or vertical direction, is determined based on the above other criteria. Upon a determination of the distance X1 and/or distance Y1, operation 902 transitions processing to an operation 903.

In operation 903, a new text origin of the page is determined based on a new page text flow direction and/or a new page line growth direction, for example, as specified by a user. Upon determination of the new text origin of the page, operation 903 transitions processing to an operation 904.

In operation 904, the anchor point is relocated, for example as earlier described with reference to FIGS. 7 and 8. Upon relocation of the anchor point, operation 904 transitions processing to an operation 905.

In operation 905, the anchor corner of the anchored frame is repositioned the distance X1 to the repositioned anchor point in the new page text flow direction and/or the distance Y1 to the repositioned anchor point in the new page line growth direction of the page. Accordingly, the user does not have to manually reposition the anchored frame upon changing a writing style of the underlying page. As the anchored frame is automatically repositioned in accordance with the introduced changes to the page, interference with an existing layout is reduced. Upon repositioning the anchor point, from operation 905, processing exits method 900 at an exit operation.

In one embodiment, the operations illustrated with respect to FIG. 9 are carried out using a data processing device, such as data processing unit 200. Thus, in some embodiments, data processing unit 200 includes a means for determining an anchor corner of the anchored frame located closest to the anchor point, and a means for defining a distance X1. In some embodiments, data processing unit 200 further includes a means for positioning the anchor point of the anchored frame the distance X1 to a repositioned anchor point in a new page text flow direction, after the page underlying the anchored frame has been modified, such as in accordance with a new writing style.

In one embodiment, the above-described means included in data processing unit 200 are embodied as a sequence of coded instructions for execution on a central processing unit of data processing unit 200 and/or are least partially implemented as hardware components.

In still other embodiments, data processing unit 200 includes a means for defining a distance Y1 and, if the parameters of the page underlying the anchored frame are changed, a means for repositioning the anchor corner of the anchored frame the distance Y1 to the repositioned anchor point in a new page line growth direction after the changes.

As earlier described, in some embodiments, only one of the distance X1 and the distance Y1 is determined, whereas another parameter defining the position of the anchored frame is a fixed position determined based on one of the page text flow direction and the page line growth direction of the page. For example, as earlier described, in some embodiments, the anchored frame is located near a vertical or horizontal center line of the page, and the fixed position is redefined based on the new page text flow direction and the new page line growth direction of the page. By way of illustration, assume an anchored frame is located in a page in relation to a vertical center line of the page, and a text flow direction of the page is rotated by 90° in one embodiment, the anchored frame is located in relation to a horizontal center line of the page after the changes.

Still further, in some embodiments, if at least one of the page text flow direction and the page line growth direction of the page is changed, a height dimension and/or a width dimension and/or a frame growth direction of the anchored frame is maintained unchanged, to reduce interference with the page layout. For example, in one embodiment, the orientation of the anchored frame as well as the height dimension and the width dimension of the anchored frame are maintained despite changes to the writing style of the page. Still further, in one embodiment, a frame growth direction of the anchored frame is maintained unchanged so long as the frame growth direction is oriented away from the anchor point/text origin of the page after the changes.

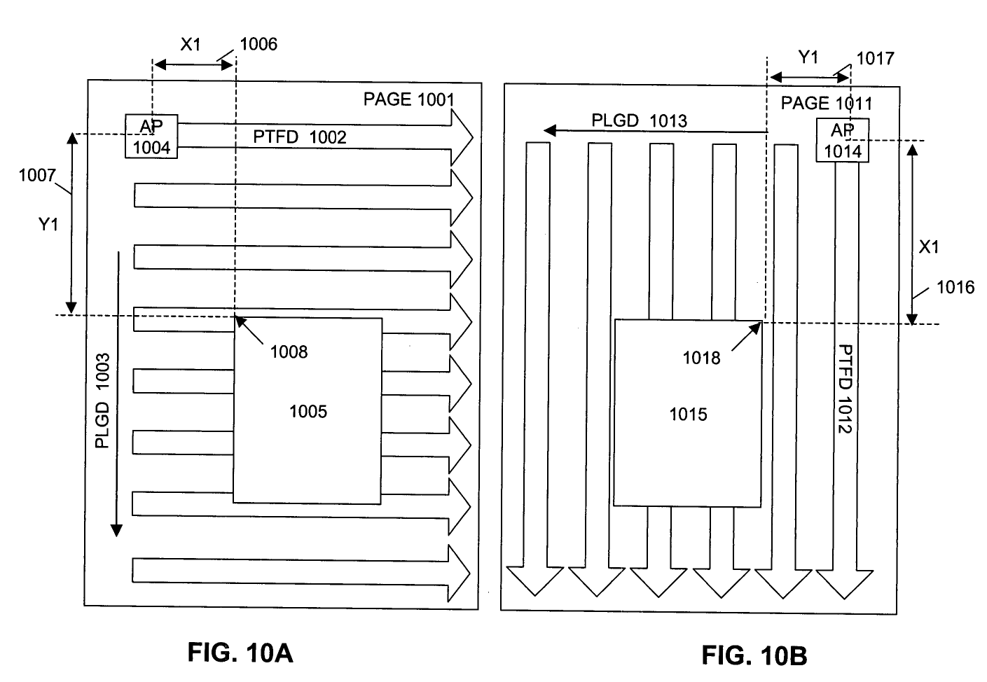

FIGS. 10A and 10B illustrate relocating an anchor point and repositioning an anchored frame in accordance with changes to a writing style of a page underlying the anchored frame in accordance with another embodiment of the invention. In FIG. 10A, a page 1001, illustrates a page before changes to the writing style of the page are effected. In FIG. 10B, page 1011 illustrates the page after changes to the writing style of page 1001 are effected.

In one embodiment, page 1001 has a page text flow direction (PTFD) 1002 in the horizontal direction from left to right and a page line growth direction (PLGD) 1003 in a downward direction, such as in the European writing style. Additionally, page 1001 includes an anchor point (AP) 1004 near the text origin of the page, i.e., the upper left corner of page 1001, the position of the first text element in a first line within page 1001. An anchored frame (AF) 1005 is located a distance X1 of length 1006 from anchor point 1004 in page text flow direction 1002.

In the present illustration, an anchor corner 1008 of anchored frame 1005 is located a distance Y1 of length 1007 from anchor point 1004 in page line growth direction 1003 of page 1001. In one embodiment, anchor corner 1008 is determined in accordance with operation 901 of FIG. 9. As earlier described, anchor corner 1008 is the corner of anchored frame 1005 located closest to anchor point 1004.

After changes to the writing style of page 1001 are effected, in the present embodiment, page 1011 has a new page text flow direction (PTFD) 1012 in a downward direction, e.g., toward the bottom of page 1011, and a new page line growth direction (PLGD) 1013 toward the left of page 1011, such as in the Chinese or Japanese writing styles.

Page 1011 further shows a repositioned anchor point (AP) 1014, repositioned in accordance with the operations of earlier described embodiments. To reduce interference with the layout of page 1011, despite the changes to the writing style, anchored frame 1015 is repositioned in accordance with new page text flow direction 1012 and new page line growth direction 1013. Thus, in one embodiment, an anchor corner 1018 of anchored frame 1015 is located a distance X1 of length 1016 in new page text flow direction 1012 and a distance Y1 of length 1017 in page line growth direction 1013 after the changes are effected.

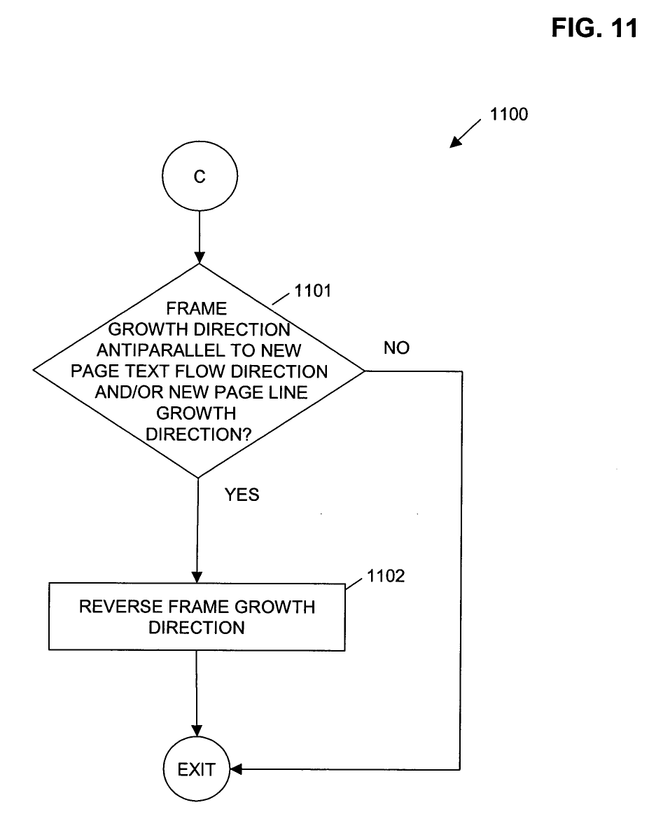

FIG. 11 illustrates a process flow diagram of a method 1100 for defining an anchored frame in a page having text elements in accordance with another embodiment of the invention. More particularly, in one embodiment, FIG. 11 describes operations to handle a frame growth direction of an anchored frame in view of changes to the writing style of a page underlying the anchored frame.

Referring now to FIGS. 7 and 11 together, in one embodiment, method 1100 is entered from method 700 at an entry point C corresponding to an exit point C shown in FIG. 7. In one embodiment, method 1100 is performed subsequent to operation 703 of method 700, however method 1100 is not limited thereto, and from entry point C processing transitions to an operation 1101.

In operation 1101, a determination is made whether a frame growth direction of an anchored frame is opposite to a new page text flow direction and/or a new page line growth direction of a page.

Upon a determination that the frame growth direction of the anchored frame is opposite to the new page text flow direction and/or the new page line growth direction of the page (“YES”), operation 1101 transitions processing to an operation 1102.

In operation 1102, in one embodiment, the frame growth direction of the anchored frame is reversed. By reversing the frame growth direction, the frame growth direction is oriented away from the text origin/anchor point of the page. Upon reversal of the frame growth direction of the anchored frame, from operation 1102, processing exits method 1100 at an exit operation.

Referring again to operation 1101, alternatively, upon a determination that the frame growth direction of the anchored frame is not opposite to the new page text flow direction and/or the new page line growth direction (“NO”), from operation 1101, processing exits method 1100 at an exit operation.

In one embodiment, the operations of FIG. 11 are carried out using a data processing device, such as data processing unit 200. In one embodiment, data processing unit 200 includes a means for determining whether a frame growth direction of an anchored frame is opposite to at least one of a new page text flow direction and a new page line growth direction after changes are made to the writing style of a page. In some embodiments, data processing unit 200 further includes a means for reversing the frame growth direction. In some embodiments, the above means of data processing unit 200 are embodied as a sequence of coded instructions for execution on a central processing unit of data processing unit 200 and/or are at least partially implemented as hardware components.

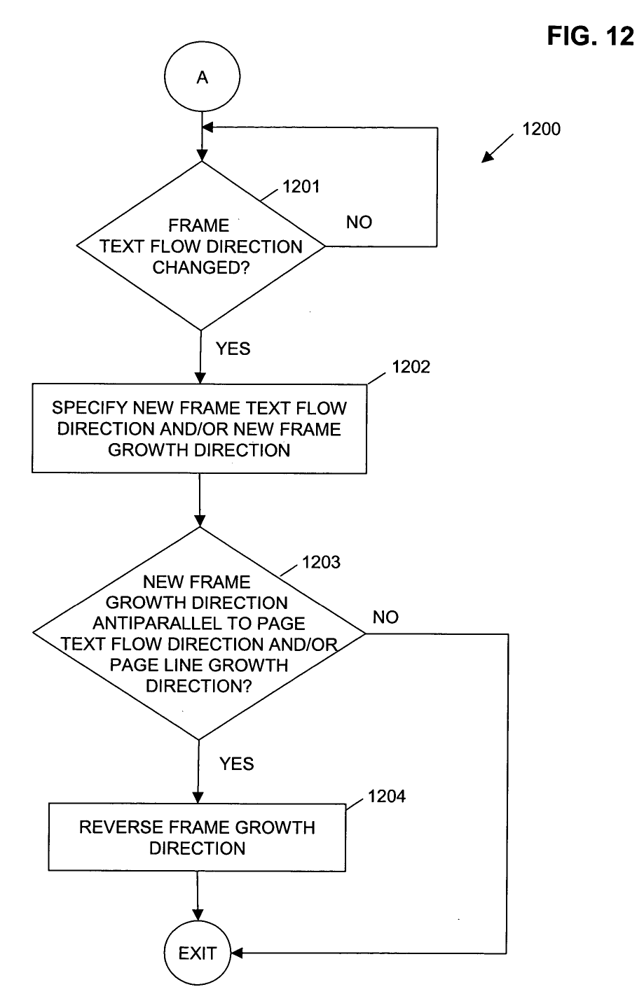

FIG. 12 illustrates a process flow diagram of a method 1200 for defining an anchored frame in a page having text elements in accordance with another embodiment of the invention. More particularly, in one embodiment, FIG. 12 illustrates defining an anchored frame in a page in which a writing style of the anchored frame is changed, while the writing style of the page is maintained unchanged.

Referring now to FIGS. 1 and 12 together, in one embodiment, method 1200 is entered from method 100 at an entry point A corresponding to an exit point A shown in FIG. 1. In one embodiment, method 1200 is performed subsequent to operations 101-104 of method 100, however method 1200 is not limited thereto. Upon entering method 1200, processing transitions from entry point A to an operation 1201.

In operation 1201, a determination is made whether a frame text flow direction of an anchored frame is changed, such as based on a user interaction. Upon a determination that the frame text flow direction of the anchored frame is not changed (“NO”), from operation 1201, processing transitions to entry point A. Alternatively, upon a determination that the frame text flow direction of the anchored frame is changed (“YES”), operation 1201 transitions processing to an operation 1202.

In operation 1202, in one embodiment, a new frame text flow direction of the anchored frame and/or a new frame growth direction of the anchored frame is determined, for example, as earlier described with reference to previous embodiments, and operation 1202 transitions processing to an operation 1203.

In operation 1203, to reduce interference with an existing layout of the page, a determination is made whether the new frame growth direction is opposite to the page text flow direction and/or the page line growth direction. Upon a determination that the new frame growth direction is not opposite to the page text flow direction and/or the page line growth direction (“NO”), from operation 1203, processing exits method 1200 at an exit operation. Alternatively, upon a determination that the new frame growth direction is opposite to the page text flow direction and/or the page line growth direction (“YES”), operation 1203 transitions processing to an operation 1204.

In operation 1204, in one embodiment, the frame growth direction is reversed. By reversing the frame growth direction of the anchored frame, the frame growth direction is oriented away from the anchor point/text origin of the page to reduce interference with a layout of the page. Upon reversing the frame growth direction, from operation 1204, processing exits process 1200 at an exit operation.

In one embodiment, the operations of method 1200 are carried out using a data processing device, such as data processing unit 200. In one embodiment, data processing unit 200 includes a means for determining if a frame text flow direction of an anchored frame was changed and a means for specifying a new frame text flow direction and a new frame growth direction of an anchored frame. In some embodiments, data processing unit 200 further includes a means for determining whether a new frame growth direction of an anchored frame is opposite to at least one of a page text flow direction and a page line growth direction of a page and a means to reverse the frame growth direction of the anchored frame. In some embodiments, the above-described means of data processing unit 200 are embodied as a sequence of coded instructions for execution on a central processing unit of data processing unit 200 and/or are at least partially implemented as hardware components.

As earlier described with reference to FIG. 11, in some embodiments, if the text flow direction of the anchored frame is changed, at least one of a height dimension, a width dimension, and frame growth direction of the anchored frame are maintained unchanged, such as based on user preference, to reduce interference with an existing layout of the page.

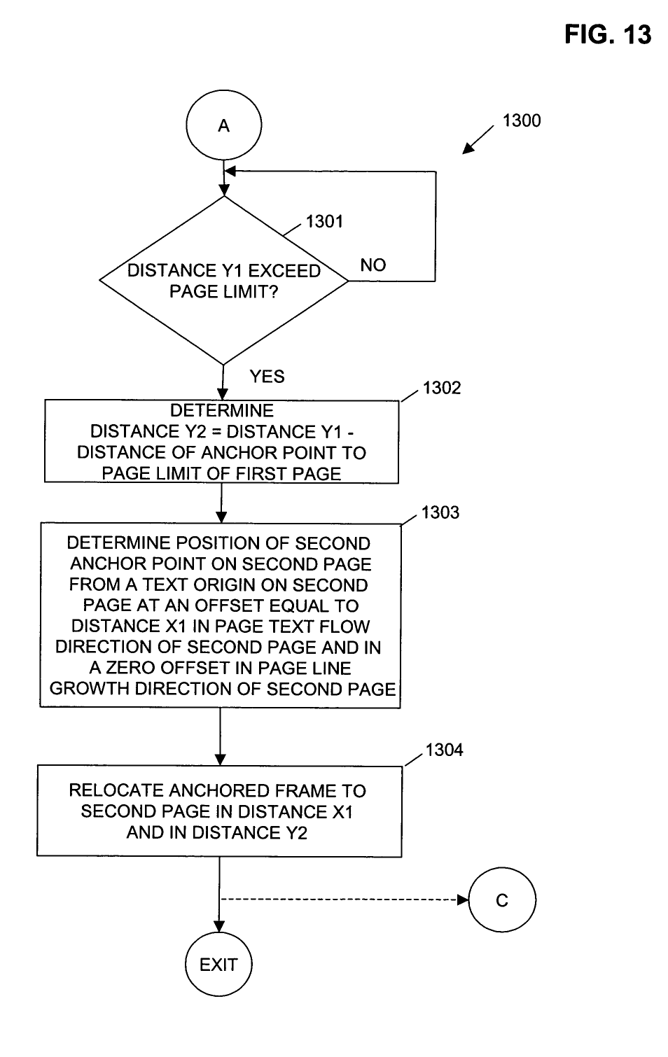

FIG. 13 illustrates a process flow diagram of a method 1300 for defining an anchored frame in a page having text elements in accordance with another embodiment of the invention. More particularly, in one embodiment, FIG. 13 describes operations for relocating an anchored frame, if an anchor corner of a frame lies outside a page limit of a page, such as when a printout of a page with an anchored frame exceeds a page limit.

For example, if a distance Y1 is the distance of an anchored frame from the anchor point and distance Y1 is defined such that the anchor corner of the anchored frame lies outside the page, i.e., exceeds a page limit, in one embodiment, the anchored frame is relocated to another page. Herein, in one embodiment, a page limit is the actual border of a page corresponding to a paper size, for example, the representational edges (left, right, top and bottom) of a page on a display. In other embodiments, the page limit may be differently defined, for example, as the limit of a region within a page, such as a region somewhat smaller than the actual paper size defining a printable region, e.g., a region in which text elements can be entered.

Referring now to FIGS. 1 and 13 together, in one embodiment, method 1300 is entered from method 100 at an entry point A corresponding to an exit point A shown in FIG. 1. In one embodiment, method 1300 is performed subsequent to operations 101-104 of method 100, however method 1300 is not limited thereto. Upon entering method 1300, from entry point A, processing transitions to an operation 1301 of method 1300.

In one embodiment, it is assumed that an anchored frame is located relative to an anchor point on a page, such as by a user, by a text processing application, or other program, with a distance Y1 in the page line growth direction exceeding the page limit of the page.

In operation 1301, a determination is made whether the distance Y1 exceeds the page limit of the page, herein termed the first page (whether the anchor corner of the anchored frame is outside the page limits).

Upon a determination that the distance Y1 does not exceed the page limit of the first page (“NO”), from operation 1301, processing transitions to entry point A. Alternatively, upon a determination that the distance Y1 exceeds the page limit of the first page (“YES”), operation 1301 transitions processing to an operation 1302.

In operation 1302, a distance Y2 is calculated by subtracting from the distance Y1, the distance from the anchor point on the first page to the page limit of the first page. That is, Y2=Y1−the distance from the anchor point on the first page to the page limit of the first page. Upon calculation of Y2, operation 1302 transitions processing to an operation 1303.

In operation 1303, a position of a second anchor point on a next page, herein termed a second page, is determined. In one embodiment, the second page is a page following in a sequential order the first page. In one embodiment, a distance X1 is calculated as the distance from the text origin on the first page to the anchor point on the first page in the page text flow direction.

In one embodiment, the position of the second anchor point is determined at location having an offset from a text origin of the second page in a page text flow direction on the second page substantially equal to the offset of the first anchor point from a text origin in a page text flow direction on the first page, i.e., a distance X1, and having an offset from the text origin in a page line growth direction on the second page of substantially zero. In one embodiment, the text origin of the second page is determined based on the page text flow direction of the second page and the page line growth direction of the second page, as earlier described, such as at a location where a first text element can be entered on a first line on the second page. Upon determination of the second anchor point on the second page, operation 1303 transitions processing to an operation 1304.

In operation 1304, the anchored frame is relocated to the second page the distance X1 from the second anchor point in a page text flow direction of the second page and the distance Y2, as calculated in operation 1302, from the second anchor point in a page line growth direction of the second page. For example, in a page with horizontal writing and a frame growth direction in a downward direction, the distance Y1 may exceed the lower edge of the page, and thus, the distance Y2 is the distance Y1 minus the distance from the anchor point to the lower edge of the page. Upon relocation of the anchored frame to the second page, from operation 1304, processing exits method 1300 at an exit operation.

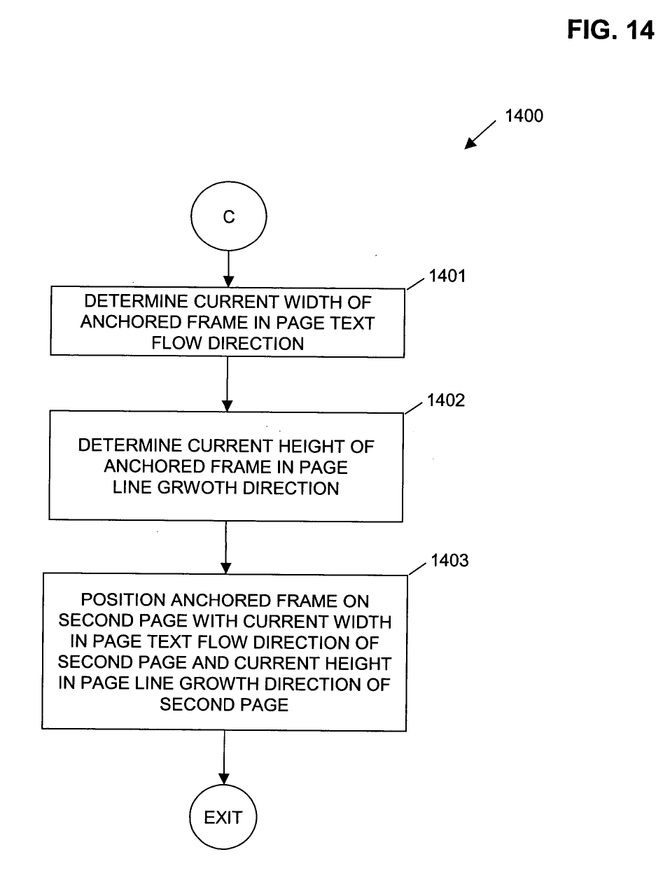

In some embodiments, optionally, from operation 1304, processing exits method 1300 at exit point C and transitions to further processing, such as earlier described with reference to FIG. 9 and/or as further described herein with reference to FIG. 14.

In one embodiment, operation 1301, and thus method 1300, is performed on a near continuous basis, while in other embodiments, operation 1301, and thus method 1300, is performed at intervals, permitting dynamic arrangement of the anchored frame on the pages. Relocating the anchored frame as described above reduces interference with an existing layout of the page, if a frame lies outside a page limit.

In one embodiment, the operations of FIG. 13 are carried out using a data processing device, such as data processing unit 200. In one embodiment, data processing unit 200 includes a means for determining whether the distance Y1 exceeds a page limit of a first page.

In some embodiments, data processing unit 200 further includes a means for calculating a distance Y2 by subtracting from the distance Y1 the distance from the anchor point on the first page to the page limit of the first page, and a means for positioning a second anchor point on a second page such that an offset from a text origin in a page text flow direction on the second page is substantially equal to the offset of the first anchor point from a text origin in a page text flow direction on the first page, i.e., distance X1, and such that there is substantially no offset, e.g., substantially zero offset, from the text origin in a page line growth direction on the second page.

For example, in one embodiment, the means for positioning the second anchor point arranges the second anchor point on the second page such that an offset from a text origin in a page text flow direction on the second page is substantially equal to the offset of the first anchor point from a text origin in a page text flow direction on the first page and such that an offset from the text origin in a page line growth direction on the second page is substantially zero.

In some embodiments data processing unit 200 further includes a means for locating the anchored frame the distance X1 from the second anchor point in a page text flow direction of the second page and the distance Y2 from the second anchor point in a page line growth direction of the second page.

In some embodiments, the above means of data processing unit 200 are embodied as a sequence of coded instructions for execution on a central processing unit of data processing unit 200 and/or are at least partially implemented as hardware components.

FIG. 14 illustrates a process flow diagram of a method 1400 for defining an anchored frame in a page having text elements in accordance with another embodiment of the invention. More particularly, in one embodiment, FIG. 14 describes operations for resizing an anchored frame, if the anchored frame is moved to a second page.

Referring now to FIGS. 13 and 14 together, in one embodiment, method 1400 is entered from method 1300 at an entry point C corresponding to an exit point C shown in FIG. 13. In one embodiment, method 1400 is performed subsequent to the operations of method 1300, however method 1400 is not limited thereto. Upon entering method 1400, processing transitions from operation 1304 of method 1300 to an operation 1401 of method 1400.

In operation 1401, a current width of the anchored frame in the page text flow direction of the page is determined. Upon determination of the current width of the anchored frame, operation 1401 transitions processing to an operation 1402.

In operation 1402, a current height of the anchored frame in the page line growth direction of the page is determined. The current width and the current height define the size of the anchored frame on the page, such as where the anchored frame exceeds a page limit. Upon determination of the current height, operation 1402 transitions processing to an operation 1403.

In operation 1403, the anchored frame is positioned on the second page with the current width of the anchored frame in the text flow direction of the second page and the current height in line growth direction of the second page. Accordingly, an orientation of the anchored frame moved from the first page to the second page is rearranged in accordance with the writing style of the second page. Upon positioning of the anchored frame on the second page, from operation 1402, processing exits method 1400 at an exit operation.

In one embodiment, the operations of FIG. 14 are carried out using a data processing device, such as data processing unit 200. In one embodiment, data processing unit 200 includes a means for determining a current width and a current height of the anchored frame in a page text flow direction and a page line growth direction of the page, respectively. Further, in some embodiments, data processing unit 200 includes a means for positioning the anchored frame on the second page with a current width in a text flow direction of the second page and a current height in a line growth direction of the second page.

In some embodiments, the above-described means of data processing unit 200 are embodied as a sequence of coded instructions for execution on a central processing unit of data processing unit 200 and/or are at least partially implemented as hardware components.

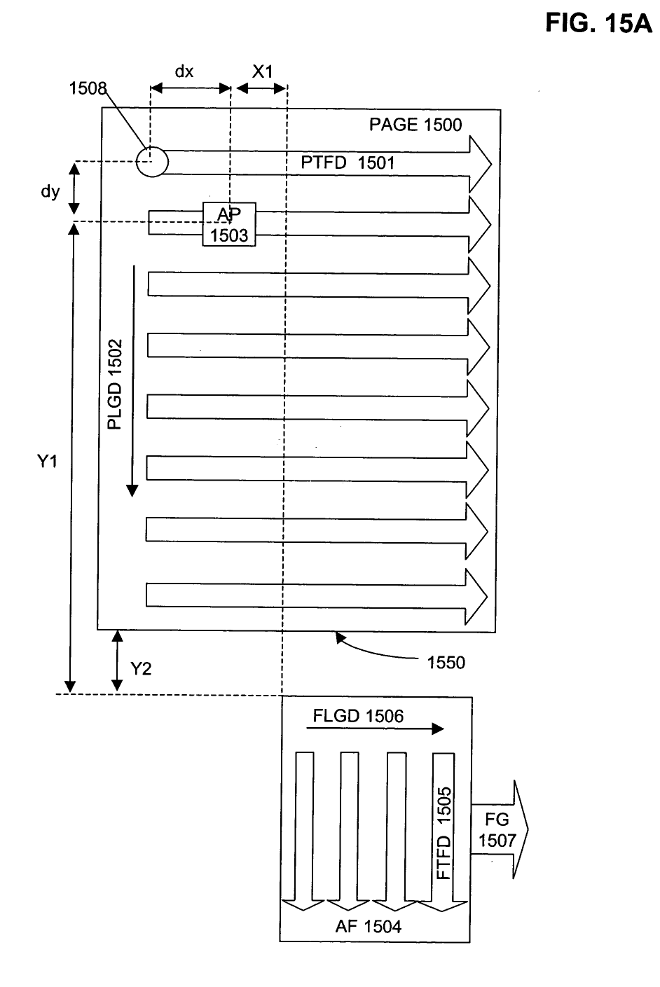

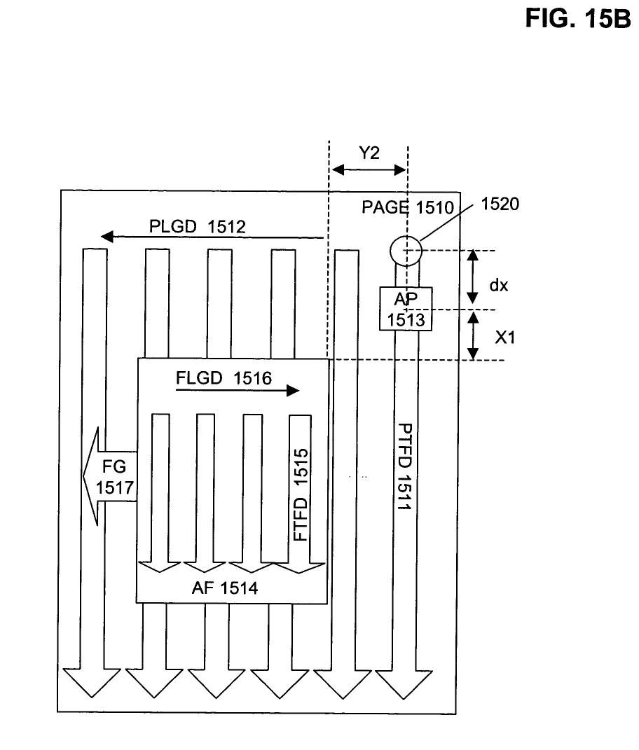

FIGS. 15A and 15B illustrate an example of defining an anchored frame in a page if the anchored frame is moved to a second page in accordance with one embodiment of the invention. In one embodiment, FIG. 15A illustrates a page 1500 with a page text flow direction (PTFD) 1501 in the horizontal direction from left to right and a page line growth direction (PLGD) 1502 in a downward orientation, such as in the European writing style.

As illustrated, page 1500 further includes an anchor point (AP) 1503 and an anchored frame (AF) 1504 a distance X1 in page text flow direction 1501 and a distance Y1 in page line growth direction 1502 of the page with regard to anchor point 1503. Anchor point 1503 is assumed to be displaced from a text origin 1508 of page 1500 by a distance dx in page text flow direction 1501 and by a distance dy in page line growth direction 1502, such as due to location by a user. In other embodiments, the anchor point is located directly near the text origin of the page.

In FIG. 15A, anchored frame 1504 has a frame text flow direction 1505 in a vertical downward direction and a frame line growth direction (FLGD) 1506 oriented toward the right in page 1500, such as in the Mongolian writing style. In one embodiment, a frame growth direction (FG) 1507 is determined in a direction oriented away from the text origin 1508/anchor point 1503 toward the right side of page 1500. Further, it is assumed that anchored frame 1504 lies outside the page limits of page 1500, i.e., that the distance Y1 exceeds a bottom edge 1550 of page 1500. As earlier described, herein, a page limit is the actual border of a page corresponding to a paper size, for example, the representational edges (left, right, top and bottom) of a page on a display. In other embodiments, the page limit may be differently defined, for example, as the limit of a region within a page, such as a region somewhat smaller than the actual paper size defining a printable region, e.g., a region in which text elements can be entered.

Due to the positioning of anchored frame 1504, e.g., outside the page limit, it is determined, such as through user input or a determination of a text processing application, or other program, that anchored frame 1504 is to be relocated on a second page 1510 as described below.

As illustrated in FIG. 15B, second page 1510 is assumed to have a page text flow direction (PTFD) 1511 in a downward direction, e.g., toward the bottom side of page 1510, and a page line growth direction (PLGD) 1512 oriented toward the left of page 1510, such as in the Chinese and Japanese writing styles.

In relocating anchored frame 1504 to second page 1510, a text origin 1520 of second page 1510 is determined and a second anchor point (AP) 1513 is positioned on second page 1510 such that an offset dx from a text origin 1520 in a page text flow direction 1511 on second page 1510 is substantially equal to the offset dx of first anchor point 1503 from text origin 1508 in page text flow direction 1501 on page 1500 and such that second anchor point 1513 exhibits substantially zero offset from text origin 1520 in page line growth direction 1512 of second page 1510.

For example, a text origin 1520 of second page 1510 is determined and second anchor point 1513 is positioned on second page 1510 such that an offset dx from text origin 1520 in page text flow direction 1511 of second page 1510 is substantially equal to the offset dx of first anchor point 1503 from text origin 1508 in page text flow direction 1501 on first page 1500 and such that an offset from text origin 1520 in page line growth direction 1512 on second page 1510 is substantially zero.

Further, in accordance with the embodiments of FIG. 13, for relocating the anchored frame to the second page, a distance Y2 is calculated as described above, and the anchored frame is relocated to second page 1510 a distance X1 in page text flow direction 1511 of second page and the distance Y2 in page line growth direction 1512 of second page 1510.

In other embodiments, rather than locating second anchor point 1513 on second page 1510, alternate methods to relocate the anchored frame to the above-described position on second page 1510 may be used. For example, in one embodiment, correspondingly adjusted distances are determined from the text origin, such as text origin 1520, on second page 1510 or from another location on second page 1510.

As illustrated in FIGS. 15A and 15B, in one embodiment, a relocated anchored frame (AF) 1514 on second page 1510 maintains frame text flow direction (FTFD) 1515 in a downward orientation and frame line growth direction (FLGD) 1516 oriented toward the right of page 1510. In other embodiments, the frame text flow direction of anchored frame 1514 on second page 1510 is changed.

Upon locating anchored frame 1514 on second page 1510, a frame growth direction (FG) 1517 of anchored frame 1514 is defined, such as earlier described, for example, in a direction oriented away from text origin 1520 and anchor point 1513 of second page 1510 toward the left side of page 1510.

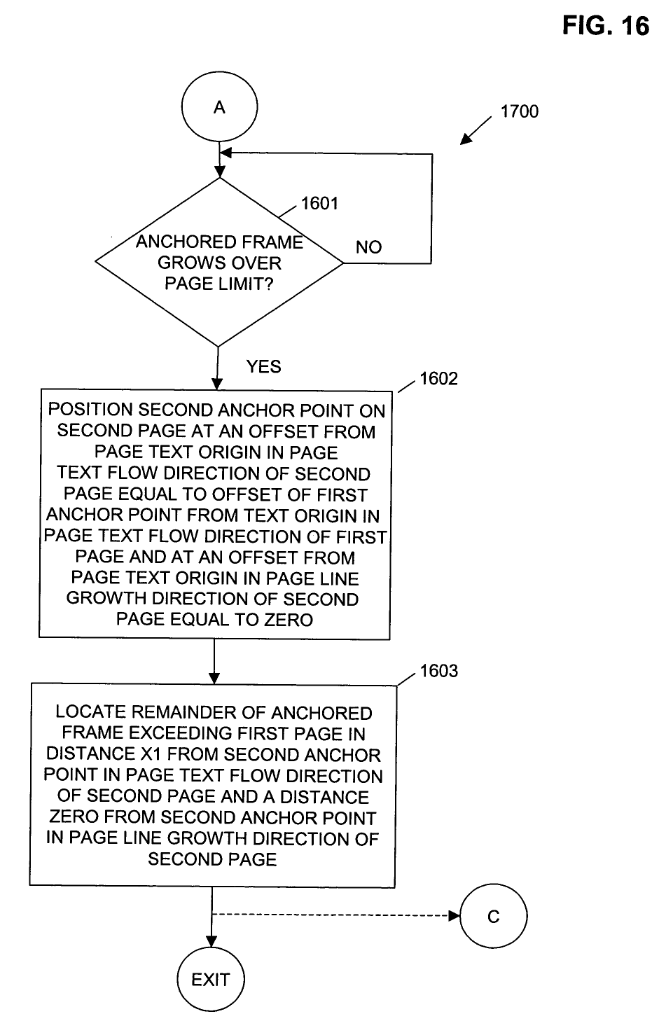

FIG. 16 illustrates a process flow diagram of a method 1600 for defining an anchored frame in a page having text elements in accordance with another embodiment of the invention. More particularly, in one embodiment, FIG. 16 describes operations for defining an anchored frame in a page when the anchored frame grows beyond a page limit of a page.

As earlier described, herein, a page limit is the actual border of a page corresponding to a paper size, for example, the representational edges (left, right, top and bottom) of a page on a display . In other embodiments, the page limit may be differently defined, for example, as the limit of a region within a page, such as a region somewhat smaller than the actual paper size defining a printable region, e.g., a region in which text elements can be entered.

In one embodiment, if the anchored frame grows over a page limit, the part of the anchored frame exceeding the page limit is relocated, for example, such as when a printout with an anchored frame exceeding a page limit cannot be accommodated.

In the present example it is assumed that an anchored frame is located on a page by a user or program and, it is assumed that the anchored frame grows, for example, based on text input to the anchored frame.

Accordingly, the anchored frame grows with the additional text being input, until at one point, the anchored frame exceeds a page limit of the page. In the present embodiment, it is assumed that the anchored frame grows beyond a page limit in a page line growth direction. However, in other embodiments, the anchored frame grows to exceed beyond the page limit in a page text flow direction.

Referring now to FIGS. 1 and 16 together, in one embodiment, method 1600 is entered from method 100 at an entry point A corresponding to an exit point A shown in FIG. 1. In one embodiment, method 1600 is performed subsequent to operations 101-104 of method 100, however method 1600 is not limited thereto. From entry point A, processing transitions to an operation 1601 of method 1600.

In operation 1601, a determination is made whether the anchored frame exceeds a page limit of a first page in page line growth direction, such as grows into a second page. Upon a determination that the anchored frame does not exceed a page limit of the first page (“NO”), operation 1602 transitions processing to entry point A. Alternatively, upon a determination that the anchored frame exceeds a page limit of the first page (“YES”), operation 1602 transitions processing to an operation 1602.

In operation 1602, a second anchor point is positioned on a second page such that an offset from a text origin in a page text flow direction on the second page is substantially equal to the offset of the first anchor point from a text origin in a page text flow direction on the first page and such that an offset from the text origin in a page line growth direction on the second page is substantially zero. Accordingly, in one embodiment, the second anchor point maintains its relative position in the page text flow direction, but is moved to the level of the text origin of the second page in the page line growth direction of the second page, for example, the “upper” page limit (the top side of the page).

In one embodiment, the second page is a second page of the text document following the first page. For example, a text document includes a plurality of pages, with the second page subsequent to a page including the anchored frame growing to exceed the page limit. Further, in one embodiment, the text origin of the second page is determined based on the page text flow direction of the second page and the page line growth direction of the second page, as earlier described. Upon positioning the second anchor point on the second page, operation 1602 transitions processing to an operation 1603.

In operation 1603, the remainder of the anchored frame exceeding the first page is located a distance X1 from the second anchor point in a page text flow direction of the second page and a distance substantially zero from the second anchor point in a page line growth direction of the second page. In the present embodiment, the remainder of the anchored frame exceeding the first page is the part of the anchored frame that exceeds the page limit of the first page. Thus, the remainder of the anchored frame “sticks” to the level of the text origin in the page line growth direction, but maintains the position in the page line growth direction as on the first page, i.e., the page with the first part of the anchored frame. Accordingly, the anchored frame is relocated with minimal interference with an existing layout of the page, if a frame grows over a page limit.

In one embodiment, operation 1601, and thus method 1600, is performed on a continuous basis. In some embodiments, operation 1601, and thus method 1600, is performed at intervals permitting the anchored frame to be dynamically arranged on the pages.

In one embodiment, the operations of FIG. 16 are carried out using a data processing device, such as data processing unit 200. In one embodiment, data processing unit 200 includes a means for determining if an anchored frame grows over a page limit of a first page in a page line growth direction, a means for positioning a second anchor point on a second page such that an offset from a text origin in a page text flow direction on a second page is substantially equal to an offset of the first anchor point from a text origin in a page text flow direction on the first page and such that an offset from the text origin in a page line growth direction on the second page is substantially zero; and a means for locating a remainder of the anchored frame exceeding the first page the distance X1 from the second anchor point in a page text flow direction of the second page and a distance of substantially zero from the second anchor point in a page line growth direction of the second page.

In some embodiments, the above-described means of data processing unit 200 are embodied as a sequence of coded instructions for execution on a central processing unit of data processing unit 200 and/or are at least partially implemented as hardware components.

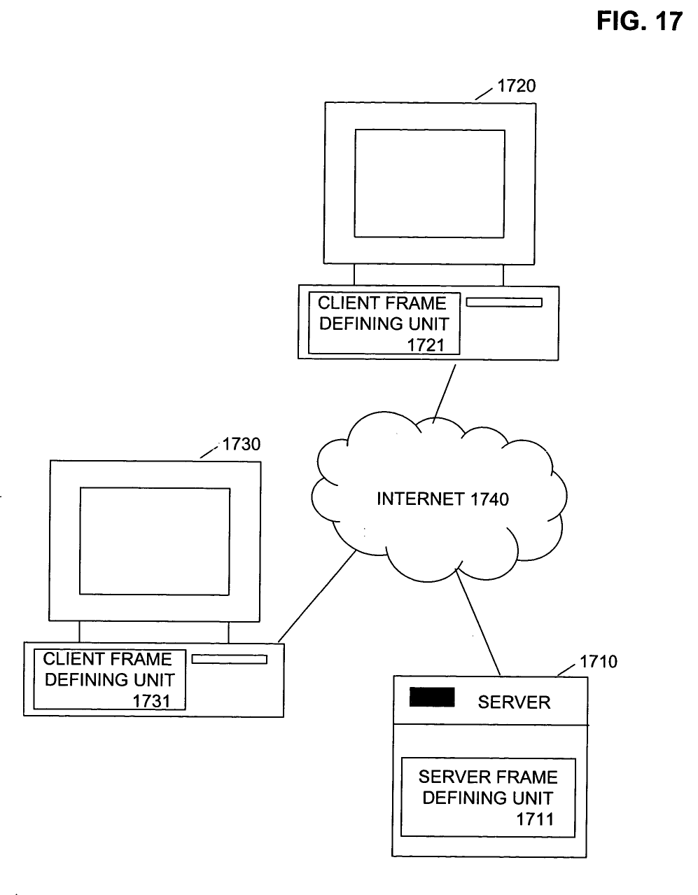

FIG. 17 illustrates a system for defining an anchored frame in a page having text elements in accordance with one embodiment of the invention. As illustrated, in one embodiment, a server unit 1710 and two exemplary client units 1720 and 1730 are communicatively coupled via a network 1740, such as the Internet.

In one embodiment, client units 1720 and 1730 are arranged to control an execution of a text processing application at server unit 1710, e.g., through user commands and through an input device, such as a keyboard, a mouse, or a pointing device, not shown. In some embodiments, client units 1720 and 1730 include general-purpose data processing devices, such as a desktop computer, a laptop computer, a palmtop computer, a personal digital assistant (PDA) and/or a communication device including mobile phones. In some embodiments, client units 1720 and 1730 include a means to establish a connection to server unit 1710, e.g., via through the Internet or using any other type of connection.

In one embodiment, server unit 1710 is arranged to execute a text processing application, such as text processing application 204 (FIG. 2A), in accordance with commands received from client units 1720 and/or 1730. Thus, in some embodiments, server unit 1710 is a data processing device with a large capacity, and capable of serving large number of users concurrently.

For example, in one embodiment, client unit 1720 launches a first instance of text processing application 204 at server unit 1710, and second client unit 1730 launches a second instance of text processing application 204 at server unit 1710.

In one embodiment, server unit 1710 includes a server frame defining unit 1711 for defining an anchored frame in a page, e.g., as generated by the text processing application. In one embodiment, server frame defining unit 1711 includes at least part of the functionalities for defining an anchored frame in accordance with the various embodiments of the invention described herein. In some embodiments, a means for defining the anchored frame is implemented as an integral part of text processing application 204, while in other embodiments, the means for defining the anchored frame is implemented as a separate application assisting text processing application 204.

In some embodiments, client units 1720 and 1730 include client frame defining units 1721 and 1731, respectively. In some embodiments, client frame defining units 1721 and 1731 include at least part of the functionalities for defining an anchored frame in accordance with the various embodiments of the invention described herein. In some embodiments, client frame defining units 1721 and 1731 and server frame defining unit 1711 are embodied as a sequence of coded instructions for execution on a processing unit. In other embodiments, client frame defining units 1721 and 1731 and server frame defining unit 1711 are at least partially implemented in hardware.

During operations, in some embodiments, server unit 1710 executes text processing application 204 and processing results, i.e., pages including anchored frames, etc., are displayed at client units 1720 and 1730. For example, in one embodiment, server unit 1710 executes operations for determining a page text flow direction and page line growth direction of a page, for locating an anchored frame near a text origin, and for defining a frame growth direction of the anchored frame oriented away from the anchor point. Further, in some embodiments, server unit 1710 is arranged to perform further operations in accordance with the various embodiments of the invention described herein.

Herein a program or a group of programs include instructions adapted to cause a group of data processing devices, such as client units 1720 and 1730 and server unit 1710, to carry out at least one of the above operations described herein.

In some embodiments, some, any, or all of the methods described herein are embodied in a computer readable medium. Herein a computer readable medium includes a program that causes a computer or a system of data processing devices to execute some, any, or all of the methods described herein. The computer-readable medium can be a magnetic or optical or other tangible medium on which a program is recorded, but can also be a signal, e.g. analog or digital, electronic, magnetic or optical, in which the program is embodied for transmission. Further, in some embodiments, a computer program product includes the computer-readable medium.

It is noted that although the operations of the methods described herein are shown and described in specific sequences and combinations, the operations are not limited thereto and may be combined in arbitrary ways in other embodiments.

In some embodiments, the invention is implemented as a processing unit for defining an anchored frame in a page having text elements. In one embodiment, the processing unit includes: a code section having instructions adapted to determine a page text flow direction of the page and a page line growth direction of the page; a code section having instructions adapted to locate an anchor point of the anchored frame near an intersection of the page text flow direction and the page line growth direction of the page; and a code section having instructions adapted to define a frame growth direction of the anchored frame to be oriented away from the anchor point.

In some embodiments, the processing unit includes: a code section having instructions adapted to determine whether the page text flow direction of the page and a frame text flow direction of the anchored frame are orthogonal to one another, and, a code section having instructions adapted to define the frame growth direction of the anchored frame to have the same direction as the page text flow direction of the page.

In some embodiments, the processing unit includes: a code section having instructions adapted to determine whether the page text flow direction of the page and a frame text flow direction of the anchored frame are opposite to one another, and, a code section having instructions adapted to define the frame growth direction of the anchored frame to have the same direction as the page line growth direction of the page.

In some embodiments, the processing unit includes a code section having instructions adapted to locate the anchor point near a text origin of the page.

In some embodiments, the processing unit includes a code section having instructions adapted to determine a new location of the anchor point based on a new page text flow direction and new text growth direction of the page, if at least one of the page text flow direction and page line growth direction of the page is changed, and a code section having instructions adapted to reposition the anchor point to the new location.

In some embodiments, the processor includes: a code section having instructions adapted to determine an anchor corner of the anchored frame located closest to the anchor point; a code section having instructions adapted to define a distance X1 from the anchor point to the anchor corner in page text flow direction of the page; and a code section having instructions adapted to position the anchor corner of the anchored frame the distance X1 to the repositioned anchor point in the new page text flow direction of the page.

In some embodiments, the processing unit includes: a code section having instructions adapted to determine an anchor corner from the anchor point located closest to the anchor point; a code section having instructions adapted to define a distance Y1 of the anchored frame to the anchor corner in page line growth direction of the page; and a code section having instructions adapted to position the anchor corner of the anchored frame the distance Y1 to the repositioned anchor point in the new page line growth direction of the page.

In some embodiments, the processor includes: a code section having instructions adapted to define a fixed position of the anchored frame based on one of the page text flow direction and the page line growth direction; and a code section having instructions adapted to redefine the fixed position based on the new page text flow direction and the new page line growth direction.

In some embodiments, the processor includes: a code section having instructions adapted to maintain unchanged at least one of a height dimension, a width dimension, and a frame growth direction of the anchored frame, if at least one of the page text flow direction and page line growth direction of the page is changed.

In one embodiment, the processor includes: a code section having instructions adapted to determine whether the frame growth direction of the anchored frame is opposite to at least one of the new page text flow direction of the page and the new page line growth direction of the page and a code section having instructions adapted to reverse the frame growth direction.

In one embodiment, the processor includes: a code section having instructions adapted to maintain unchanged at least one of a height dimension, a width dimension, and a frame growth direction of the anchored frame, if the text flow direction of the anchored frame is changed.

In some embodiments, the processor includes: a code section having instructions adapted to specify a new frame text flow direction of the anchored frame and a new frame growth direction of the anchored frame, if the text flow direction of the anchored frame is changed; a code section having instructions adapted to determine whether the new frame growth direction of the anchored frame is opposite to at least one of the page text flow direction and the page line growth direction of the page; and a code section having instructions adapted to reverse the frame growth direction.

In some embodiments, the processor includes: a code section having instructions adapted to determine a text origin of the second page, if a frame grows over a page limit into a second page; a code section having instructions adapted to position a second anchor point near the text origin of the second page; and a code section having instructions adapted to move the anchored frame to the second page.

In some embodiments, the processor includes: a code section having instructions adapted to determine if the distance Y1 exceeds a page limit of a first page, and to calculate a distance Y2 by subtracting from the distance Y1 the distance from the anchor point on the first page to the page limit of the first page; a code section having instructions adapted to position a second anchor point on a second page such that an offset from a text origin in a page text flow direction on the second page is substantially equal to the offset of the first anchor point from a text origin in a page text flow direction on the first page and such that there is substantially no offset from the text origin in a page line growth direction on the second page; and a code section having instructions adapted to locate the anchored frame the distance X1 from the second anchor point in a page text flow direction of the second page and the Y2 from the second anchor point in a page line growth direction of the second page.

In some embodiments, the processor includes: a code section having instructions adapted to determine if the anchored frame grows over a page limit of a first page in page line growth direction; a code section having instructions adapted to position a second anchor point on a second page such that an offset from a text origin in a page text flow direction on the second page is substantially equal to the offset of the first anchor point from a text origin in a page text flow direction on the first page and with substantially no offset from the text origin in a page line growth direction on the second page; and a code section having instructions adapted to locate a remainder of the anchored frame exceeding the first page the distance X1 from the second anchor point in a page text flow direction of the second page and a distance of substantially zero from the second anchor point in a page line growth direction of the second page.

In some embodiments, the processor includes a code section having instructions adapted to make the anchored frame inherit at least one of the page text flow direction and the page line growth direction from the page.

Although particular embodiments of the present invention have been shown and described, it will be apparent to those skilled in the art that changes and modifications may be made without departing from the present invention in its broader aspects. Therefore, the embodiments described herein are illustrative only and are not intended to limit the invention to the specific embodiments described.

What is claimed is:

1. A method for defining an anchored frame in a page having text elements, the method comprising:
determining a page text flow direction of the page;
determining a page line growth direction of the page;
locating an anchor point of the anchored frame near an intersection of the page text flow direction and the page line growth direction; and
defining a frame growth direction of the anchored frame oriented away from the anchor point to reduce interference with the text elements in the page.

2. The method of claim 1, wherein the frame growth direction comprises:
at least one of a frame text flow direction of the anchored frame and a frame line growth direction of the anchored frame.

3. The method of claim 2, wherein the frame growth direction comprises a frame text flow direction of the anchored frame, the method further comprising:
determining whether the page text flow direction and the frame text flow direction are orthogonal to one another; and
upon a determination that the page text flow direction and the frame text flow direction are orthogonal to one another, defining the frame growth direction to have the same direction as the page text flow direction.

4. The method of claim 3, further comprising:
determining whether the page text flow direction and the frame text flow direction are antiparallel; and
upon a determination that the page text flow direction and the frame text flow direction are antiparallel, defining the frame growth direction to have the same direction as the page line growth direction.

5. The method of claim 2, further comprising:
locating the anchor point near a text origin of the page.

6. The method of claim 1, wherein if at least one of the page text flow direction and the page line growth direction is changed, said method further comprising:
determining a new location of the anchor point based on a new page text flow direction and new page line growth direction; and
repositioning the anchor point to the new location.

7. The method of claim 6, further comprising:
determining an anchor corner of the anchored frame located closest to the anchor point;
defining a distance X1 from the anchor point to the anchor corner in the page text flow direction; and
positioning the anchor corner of the anchored frame the distance X1 from the new location of the anchor point in the new page text flow direction.

8. The method of claim 6, further comprising:
determining an anchor corner of the anchored frame located closest to the anchor point;
defining a distance Y1 from the anchor point to the anchor corner in the page line growth direction; and
positioning the anchor corner of the anchored frame the distance Y1 from the new location of the anchor point in the new page line growth direction.

9. The method of claim 6, further comprising:
defining a fixed position of the anchored frame based on one of the page text flow direction and the page line growth direction; and
redefining the fixed position of the anchored frame based on the new page text flow direction and the new page line growth direction.

10. The method of claim 1, wherein if at least one of the page text flow direction and the page line growth direction is changed, the method further comprising:
maintaining unchanged at least one of a height dimension, a width dimension; and a frame growth direction of the anchored frame.

11. The method of claim 6, further comprising:
determining whether the frame growth direction of the anchored frame is opposite to at least one of the new page text flow direction and the new page line growth direction; and
upon a determination that the frame growth direction of the anchored frame is opposite to at least one of the new page text flow direction and the new page line growth direction, reversing the frame growth direction.

12. The method of claim 1, wherein the anchored frame has a frame text flow direction, and further wherein if the frame text flow direction of the anchored frame is changed, the method further comprising:
maintaining unchanged at least one of a height dimension, a width dimension; and a frame growth direction of the anchored frame.

13. The method of claim 1, wherein the anchored frame has a frame text flow direction, and further wherein, if the frame text flow direction of the anchored frame is changed, the method further comprising:
specifying a new frame text flow direction of the anchored frame and a new frame growth direction of the anchored frame;
determining whether the new frame growth direction of the anchored frame is opposite to at least one of the page text flow direction and the page line growth direction; and
upon a determination that the new frame growth direction of the anchored frame is opposite to at least one of the page text flow direction and the page line growth direction, reversing the frame growth direction.

14. The method of claim 8, wherein if the distance Y1 exceeds a page limit of the page, the method further comprising:
calculating a distance Y2 by subtracting from the distance Y1 the distance from the anchor point on the page to the page limit of the page;
positioning a second anchor point on a next page such that an offset from a text origin in a page text flow direction on the next page is substantially equal to the offset of the first anchor point from a text origin in a page text flow direction on the page and such that there is substantially no offset from the text origin in a page line growth direction on the next page; and
locating the anchored frame the distance X1 from the second anchor point in a page text flow direction of the next page and the distance Y2 from the second anchor point in a page line growth direction of the next page.

15. The method of claim 1, wherein if the anchored frame grows over a page limit of the page in the page line growth direction, the method further comprising:
positioning a second anchor point on a next page such that an offset from a text origin in a page text flow direction on the next page is substantially equal to the offset of the first anchor point from a text origin in a page text flow direction on the page and with substantially no offset from the text origin in a page line growth direction on the next page; and
locating a remainder of the anchored frame exceeding the page the distance X1 from the second anchor point in a page text flow direction of the next page and a distance of substantially zero from the second anchor point in a page line growth direction of the next page.

16. The method of claim 14, further comprising:
determining a current width of the anchored frame in page text flow direction of the page;
determining a current height of the anchored frame in page line growth direction; and
positioning the anchored frame on the next page with the current width in text flow direction of the next page and the current height in line growth direction of the next page.

17. The method claim 1, wherein the anchored frame inherits at least one of the page text flow direction and the page line growth direction from the page.

18. A processing unit for defining an anchored frame in a page having text elements, comprising:
a means for determining a page text flow direction of the page and a page line growth direction of the page;
a means for locating an anchor point of the anchored frame near an intersection of the page text flow direction and the page line growth direction of the page; and
a means for defining a frame growth direction of the anchored frame to be oriented away from the anchor point to reduce interference with the text elements in the page.

19. The processing unit of claim 18, further comprising:
means for determining at least one of a frame growth direction of the anchored frame and a frame line growth direction of the anchored frame.

20. The processing unit of claim 19, further comprising:
a means for determining whether the page text flow direction of the page and the frame text flow direction of the anchored frame are orthogonal to one another; and
means for defining the frame growth direction of the anchored frame to have the same direction as the page text flow direction of the page.

21. The processing unit of claims 19, further comprising:
a means for determining whether the page text flow direction of the page and a frame text flow direction of the anchored frame are antiparallel; and
a means for defining the frame growth direction of the anchored frame to have the same direction as the page line growth direction of the page.

22. The processing unit of claim 18, further comprising:
a means for locating the anchor point near a text origin of the page.

23. The processing unit of claim 18, further comprising:
a means for determining a new location of the anchor point based on a new page text flow direction and new page line growth direction of the page; and
a means for repositioning the anchor point to the new location if at least one of the page text flow direction and page line growth direction of the page is changed.

24. The processing unit of claim 23, further comprising:
a means for determining an anchor corner of the anchored frame located closest to the anchor point;
a means for defining a distance X1 from the anchor point to the anchor corner in page text flow direction of the page; and
a means for positioning the anchor corner of the anchored frame the distance X1 to the repositioned anchor point in the new page text flow direction of the page.

25. The processing unit of claim 23, further comprising:
a means for determining an anchor corner from the anchor point located closest to the anchor point;
a means for defining a distance Y1 of the anchored frame to the anchor corner in page line growth direction of the page; and
a means for positioning the anchor corner of the anchored frame the distance Y1 to the repositioned anchor point in the new page line growth direction of the page.

26. The processing unit claim 23, further comprising:
a means for defining a fixed position of the anchored frame based on one of the page text flow direction and the page line growth direction; and
a means for redefining the fixed position based on the new page text flow direction and the new page line growth direction.

27. The processing unit of claim 18, further comprising:
a means for maintaining unchanged at least one of a height dimension, a width dimension, and a frame growth direction of the anchored frame if at least one of the page text flow direction and page line growth direction of the page is changed.

28. The processing unit of claim 23, further comprising:
a means for determining whether the frame growth direction of the anchored frame is opposite to at least one of the new page text flow direction of the page and the new page line growth direction of the page; and
a means for reversing the frame growth direction.

29. The processing unit of claim 18, further comprising:
a means for maintaining unchanged at least one of a height dimension, a width dimension, and a frame growth direction of the anchored frame if the text flow direction of the anchored frame is changed.

30. The processing unit of claim 19, further comprising:
a means for specifying a new frame text flow direction of the anchored frame and a new frame growth direction of the anchored frame if the frame text flow direction of the anchored frame is changed; and
a means for determining whether the new frame growth direction of the anchored frame is opposite to at least one of the page text flow direction and the page line growth direction of the page; and
a means for reversing the frame growth direction.

31. The processing unit of claim 25, further comprising:
a means for determining if the distance Y1 exceeds a page limit of the page, and for calculating a distance Y2 by subtracting from the distance Y1 the distance from the anchor point on the page to the page limit of the page;
a means for positioning a second anchor point on a next page such that an offset from a text origin in a page text flow direction on the next page is substantially equal to the offset of the first anchor point from a text origin in a page text flow direction on the page and with substantially no offset from the text origin in a page line growth direction on the next page; and
a means for locating the anchored frame the distance X1 from the second anchor point in a page text flow direction of the next page and the distance Y2 from the second anchor point in a page line growth direction of the next page.

32. The processing unit of claim 18, further comprising:
a means for determining if the anchored frame grows over a page limit of the page in the page line growth direction;
a means for positioning a second anchor point on a next page such that an offset from a text origin in a page text flow direction on the next page is substantially equal to the offset of the first anchor point from a text origin in a page text flow direction on the page and with substantially no offset from the text origin in a page line growth direction on the next page; and
a means for locating a remainder of the anchored frame exceeding the page a distance X1 from the second anchor point in a page text flow direction of the next page and a distance of substantially zero from the second anchor point in a page line growth direction of the next page.

33. The processing unit of claim 31, further comprising:
a means for determining a current width of the anchored frame in page text flow direction of the page;
a means for determining a current height of the anchored frame in page line growth direction; and
a means for positioning the anchored frame on the next page with the current width in page text flow direction of the next page and the current height in the page line growth direction of the next page.

34. The processing unit of claim 18, wherein the anchored frame is arranged to inherit at least one of the page text flow direction and the page line growth direction from the page.

35. A computer readable medium including a program that causes a computer to execute a method comprising:
determining a page text flow direction of the page;
determining a page line growth direction of the page;
locating an anchor point of the anchored frame near an intersection of the page text flow direction and the page line growth direction; and
defining a frame growth direction of the anchored frame oriented away from the anchor point to reduce interference with the text elements in the page.

36. The computer readable medium of claim 35, wherein the frame growth direction comprises:
at least one of a frame text flow direction of the anchored frame and a frame line growth direction of the anchored frame.
